(19) United States
(12) Patent Application Publication
(10) Pub. No.: US 2016/0293036 A1
(43) Pub. Date: Oct. 6, 2016

(54) SYSTEM AND METHOD FOR ADAPTIVE ASSESSMENT AND TRAINING

(71) Applicant: Kaplan, Inc., New York, NY (US)

(72) Inventors: David Niemi, Santa Barbara, CA (US); Wathsala Werapitiya, Santa Barbara, CA (US); Richard S. Brown, Santa Barbara, CA (US); Johan Smith, Santa Barbara, CA (US)

(21) Appl. No.: 15/090,598

(22) Filed: Apr. 4, 2016

Related U.S. Application Data
(60) Provisional application No. 62/142,967, filed on Apr. 3, 2015.

(51) Int. Cl. G09B 7/077; G09B 19/06

(52) U.S. Cl. CPC G09B 7/077; G09B 19/06

(57) ABSTRACT

An adaptive system, method, and computer-readable medium having instructions thereon for implementing a method via a processor are provided to determine a user's level of proficiency in a specific area. In embodiments, a user's level of proficiency is determined using a machine-learning system in which the system and method adapt to the user's level, based on that user's inputted answers and other users' inputted answers, in order to create a more insightful process of determination based on the user's comprehension and other factors observed via processor.

### CROSS-REFERENCE TO RELATED APPLICATIONS

The present invention claims priority to U.S. Provisional Patent Application Ser. No. 62/142,967, having title SYSTEM AND METHOD FOR ADAPTIVE LANGUAGE PROFICIENCY TEST AND TRAINING, filed on Apr. 3, 2015, the entirety of which is hereby incorporated by reference in its entirety. The present invention incorporates herein by reference the entirety of PCT International Patent Application No. PCT/US16/25943, having title SYSTEM AND METHOD FOR ADAPTIVE ASSESSMENT AND TRAINING, filed on Apr. 4, 2016, having Attorney Docket No. 037180.00015.

### FIELD OF THE INVENTION

The present invention relates to a system, method, and computer-readable medium for performing a method or set of instructions to be carried out by a processor, for an adaptive gauging system. More specifically, the present invention relates to an adaptive system for determining a user's level of proficiency or providing a training in a certain area.

### RELATED INFORMATION

Nearly one in ten working age US adults between the ages of 16 and 64 is considered to be limited in English proficiency. It has been reported that effective English language instruction is an essential antipoverty tool. According to reports, poverty and need for public benefits such as food stamps, are more closely associated with those who are limited in their English proficiency, rather than those who do not have US citizenship or legal status. Further, many who are limited in their English language abilities cannot always commit to regular attendance at a course. This is just one industry example of many where abilities of a user are needed to be assessed, addressed, and reassessed.

Accordingly, there is a need for a high-quality engaging content program that can be utilized on demand, and can effectively and accurately gauge a mastery of skills and competencies. Further, there is a need for a system that allows for accelerated learning users to skip already-mastered content based on automatic or on demand assessments of their prior learning or skills. Further, there is a need for a system that defines gaps in a user's mastery, and/or identifies what further courses or studies are recommended for addressing the gap or fault.

### SUMMARY

Embodiments of the present invention provide for a system, method, and computer-readable medium for performing a method or set of instructions to be carried out by a processor, for an adaptive gauging and/or training system. Embodiments of the present invention provide for an adaptive or machine learning system for determining a user's level of proficiency in a specific area such as language, mathematics, science, art, social studies, history, foreign language, comprehension, cognitive skills, etc. Embodiments of the present invention provide for an adaptive or machine learning system for training a user to achieve or attempt to achieve a specific level of proficiency in a specific area such as language, mathematics, science, art, social studies, history, foreign language, comprehension, cognitive skills, etc.

Embodiments of the present invention provide for an assessment of skills, e.g., language skills, which is adaptive to a student's needs, adaptive by continuously receiving assessment data and adjusting dynamically to the skill level of a student. Embodiments of the present invention provides for artificial intelligence (Al) or machine learning by feeding back students' or users' answers and testing tracks, to allow the testing application to learn which questions or strings of questions are appropriate for specific skill levels.

An embodiment of the present invention is an English as a second (ESL) or foreign language (EFL) adaptive assessment system with accuracy efficiency, and accessibility. An embodiment of the present invention builds upon the Common European Framework of Reference (CEFR), In an embodiment, an Item Response Theory (IRT) algorithm is implemented to instantly pinpoint initial ability, prescribe development areas, and cumulatively track individual progress over time. In an embodiment, the system is a business to business (B2B), business to industry (B2I) and business to government (B2G) software as a service (SaaS) and consultative solution for businesses, schools, and governments needing to assess ESL/EFL language proficiency.

An embodiment of the present invention is a computer adaptive assessment tool that adjusts the difficulty of test items according to the estimated abilities of individual test taker(s). The tool uses a customized system including an Item Response Theory (IRT) engine in order to generate more difficult items for higher-performing test takers and easier items for lower-performing test takers. Computer adaptive assessments, according to those of the present embodiment, require fewer items to establish an individual's ability level than those using paper and pencil tests. Some advantages of the present invention include: shorter test events that provide precise estimates of test taker ability; improved testing experience, i.e., test events adjust to the test taker's ability so that individuals are not attempting tests that are too easy or too difficult; decreased cheating, i.e., no two test takers attempt exactly the same configuration of items; and more cost effective since paper-based tests do not need to be reproduced or graded by hand for each test taker.

In an embodiment, the system is a cloud-based and/or mobile assessment platform that gives customers/licensees the ability to easily administer assessments in their own setting and on their own schedule. In an embodiment, the system is a data analytics tool that enables customers/licensees to define cohorts and/or measure learning progress. In an embodiment, the system is scientifically equated to the International English Language Testing System (IELTS), Cambridge Exam, and/or the Test of English as a Foreign Language exam (TOEFL).

In an embodiment, the system is arranged to test users in order to gauge a specific question or skill level. For example, some question or skill levels can include: language ability, correlation between employee retention and progress in language (or other) learning, percentage of employees need more training and what training is needed (listening, speaking, writing, grammar, reading, other certification, etc.). For example, some question or skill levels can include: are the longest tenured teachers more effective than new hires, are teachers with advanced degrees more effective than others, what ESL skills are needed to address in a remedial course, how many hours of instruction are needed to master certain subskills or microskills. For example, some question or skill levels can include: which nationalities applying for citizenship need the most additional training and in which skill(s). what is the minimum and average CEFR (Common European Framework of Reference) entrance level or ELTS equivalency score for students, how effective is each ESL school at increasing proficiency, are specific programs more equally effective.

Embodiments of the present invention can be used by any entity interested in gauging, assessing or training in a specific area. Embodiments of the present invention can be more specifically useful to international and national vocational schools, colleges and universities teaching in English, colleges and universities recruiting abroad, J-1 Visa programs including Work and Travel, Au Pair, and Camp Counselor programs, High School, College and University Students, Research Scholars, Pathways-type programs (BEO), Government, employers, EFL chains, college prep programs, K-12 school districts, call centers, publishing partners, and the like.

Embodiments of the present invention provide an assessment system, method, and computer-readable medium having instructions thereon which are executable by a processor or computer. The assessment embodiment includes one, some, or all of the following features: cloud-based; mobile-enabled; cumulative progress tracking; customizable; standardized test concordance; no test center required; adaptive; machine learning; prescriptive recommendations; aligned to CEFR (for languages); suited for placement testing and progress testing; and exit testing; configured to test grammar, reading, listening, speaking, and writing for languages, automated scoring; overall and skill scoring; Americans with Disabilities Act (ADA) accessible; and allows for introduction of human raters input and participating during speaking and writing. In industry, no other well-known language testing system incorporates all of the aforementioned features.

Embodiments of the present invention are ADA accessible. For example, in an embodiment, a web or computer-based version of the present invention is provided, having been tested against WCAG 2.0 level AA guidelines. In an embodiment, the following automated tools are employed: Accessibility Developer Tools (a Chrome extension) and aXe Developer Tools. In an embodiment, the following screen readers are employed: ChromeVox (a Chrome extension) and VoiceOver. In an embodiment, various third party tools with accessibility support can be used, including: Ng-aria (to enhance accessibility of the core Angular modules), UI Bootstrap (to provide ARIA attributes in interactive elements), and Angular Agility (to handle accessible forms). In an embodiment, user interface features have a contrast ratio of 4.5:1 for normal text and 3:1 for large text (e.g., 14 point and bold, or 18 point, or larger). In an embodiment, interactive elements have clear “selected” state or focus indicators so that they can be used without a mouse. This includes all form elements, buttons and site navigation. In an embodiment, various features as described herein have been implemented in order to benefit those with reading disorders or cognitive diseases.

Embodiments of the present invention can be used via the internet/cloud, mobile-enabled, mobile application, downloadable executable file, via a computer-readable medium, etc.

### BRIEF DESCRIPTION OF THE DRAWINGS

FIG. 1 show an example mapping according to an embodiment of the present invention.

FIG. 2 shows an example mapping according to an embodiment of the present invention.

FIG. 3 shows an example mapping according to an embodiment of the present invention.

FIG. 4 shows an example mapping according to an embodiment of the present invention.

FIG. 5 shows an example proficiency level setting according to an embodiment of the present invention.

FIG. 6 shows an example proficiency level setting according to an embodiment of the present invention.

FIG. 7 shows an example architecture according to an embodiment of the present invention.

FIG. 8 shows an example structure according to an embodiment of the present invention.

FIG. 9 shows an example user interface according to an embodiment of the present invention.

FIG. 10 shows an example user interface according to an embodiment of the present invention.

FIG. 11 shows an example user interface according to an embodiment of the present invention.

FIG. 12 shows an example user interface according to an embodiment of the present invention.

FIG. 13 shows an example results assessment according to an embodiment of the present invention.

FIG. 14 shows an example process according to an embodiment of the present invention.

FIG. 15 shows an example process according to an embodiment of the present invention.

FIG. 16 shows an example process according to an embodiment of the present invention.

FIG. 17 shows an example process according to an embodiment of the present invention.

FIG. 18 shows an example process according to an embodiment of the present invention.

FIG. 19A shows an example backend process according to an embodiment of the present invention.

FIG. 19B shows an example backend process according to an embodiment of the present invention.

FIG. 20 shows an example process according to an embodiment of the present invention.

FIG. 21 shows an example process according to an embodiment of the present invention.

FIG. 22 shows an example process according to an embodiment of the present invention.

FIG. 23 shows an example process according to an embodiment of the present invention.

FIG. 24 shows an example process according to an embodiment of the present invention.

FIG. 25 shows an example process according to an embodiment of the present invention.

FIG. 26 shows example metadata according to an embodiment of the present invention.

### DETAILED DESCRIPTION

An embodiment of the present invention is at least one of a system, method, device, computer-readable medium having an executable program thereon, and computer program product. An embodiment of the present invention provides for objective assessment of language skills, using an adaptive learning system continuously receiving assessment data. For example, the embodiment can provide reliable English language proficiency evaluations. Having a reliable assessment of English language skills allows institutions to make informed decisions about selection, placement, and advancement.

In an embodiment, the system is flexible and adaptive, tracking progress of test takers through an advancement of language skills. In an embodiment, the system provides detailed results to educators and other institutions to understand a person's skills and/or knowledge, and any gaps that may exist. The system can be based on the Common European Framework of Reference (CEFR) and The Evaluation and Accreditation of Quality and Language Services (EAQUALS) Core Inventory, which are known accepted frameworks for measurement of language, and English language proficiency. In an embodiment, the system provides accurate assessment and predict language scores on known standardized tests, including the Test of English as a Foreign Language (TOEFL), Cambridge English exams, and International English Language Testing System (IELTS).

In an embodiment, the system provides for a highly-detailed hierarchy of skills derived from the CEFR. In an embodiment, the system provides for multi-step research-based item development processes aligned to the proprietary skill hierarchy. In an embodiment, the system provides processes for developing skill hierarchies. In an embodiment, item development blueprints embedding the hierarchies are provided. In an embodiment, a database of CEFR-aligned, IRT-scaled items are provided. In an embodiment, IRT item scaling that enables ability estimations linked to the CEFR, recommendation of skills to work on, measurement of progress, and scaling of skills is provided. In an embodiment, scaling provides a check on the estimated level of each item. In an embodiment, cut scores for proficiency levels based on a study of scores achieved by students at different levels and adjusted and validated using data on successful placements is provided. In an embodiment, a method for combining adaptive test scores with performance scores (e.g., writing and speaking) is provided. In an embodiment, a highly detailed item tagging involving multi-level skill descriptors, item formats, time limits, and others, are provided.

In an embodiment, student language proficiency level is determined, growth in a student's proficiency over one year or multiple years is measured, and skill areas needing improvement are recommended. In an embodiment, the system includes a user interface, an item delivery and data collection system (e.g., creates actual exam instances, collects student responses), a modified IRT engine (uses item response theory type algorithms and relationships to select items for each student based on the student's responses to all previous items; can be 1-, 2-, or 3-parameter, e.g., a 3PL engine accounts for item difficulty, item discrimination, and a guessing factor; items selected to maximize information based on student ability estimate and item parameters), database storing calibrated items, item parameters, and other information and student responses, and a report generator (reporting student language proficiency level, change in proficiency level over time, individual strengths and weaknesses based in part at least on IRT scaling of skills, descriptive data by teacher, school, program, etc., data export into a spreadsheet or other location, etc.).

In an embodiment, the system includes a customized IRT engine, an assessment engine, an access control layer, a scoring and reporting device, and an item bank. The access control layer includes an authentication of a user to the system and authentication of a tenant having access by role to the data of a specific user or cohort. The scoring and reporting device includes functions of scaling estimates, mapping scores to levels, results reporting including filtering by tenant, status, date, etc., view attempt(s), view multiple assessment progress, and administrative assessment re-set. The item bank includes management of metadata, author items including multiple choice questions, group questions or items, productive items, etc. The item bank can also include a management of items including functions of search, filter criteria, and activation/deactivation of specific items. The item bank can also include uploaded calibrated difficulty data.

In an embodiment, categories of test focus for each section can include: listening (overall listening comprehension, understanding conversation between native speakers, listening as a member of a live audience, listening to announcements and instructions, listening to audio media and recordings, identifying cues and inferring); reading (overall reading comprehension, reading correspondence, reading for orientation, reading for information and argument, reading instructions, identifying cues and inferring); grammar (discourse markers, verb forms and tenses, gerunds and infinitives, conditionals, passive voice, modals, articles, determiners, adjectives, adverbs, intensifiers, questions, nouns, pronouns, possessives, prepositions); speaking (overall spoken production, sustained monologue describing experience, making an argument, simulated spoken interaction, information exchange, spoken fluency, vocabulary range, grammatical accuracy, coherence and cohesion, sociolinguistic appropriateness); and writing (overall written production, reports and essays, correspondence, notes, messages, and forms, orthographic control, vocabulary range, grammatical accuracy, coherence and cohesion, sociolinguistic appropriateness).

In an embodiment, for example, the system's item bank includes multiple choice items for listening, reading, and grammar sections, and includes items for all levels pre-A1 to C2. The speaking section includes at least four levels of test forms administered after the adaptive section of the exam predicts the test taker's level. In an embodiment, each form includes at least four tasks which can include an interview, description, simulated interaction (e.g., voicemail message, simulated conversation response), and/or speech task depending on the level of the form. In an embodiment, the writing section including writing correspondence and writing essays and reports tasks.

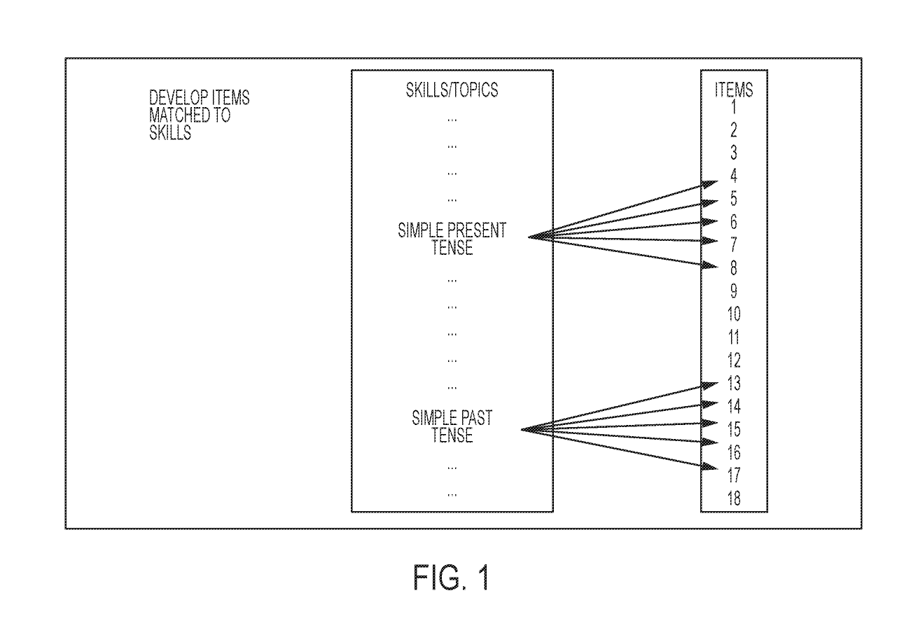

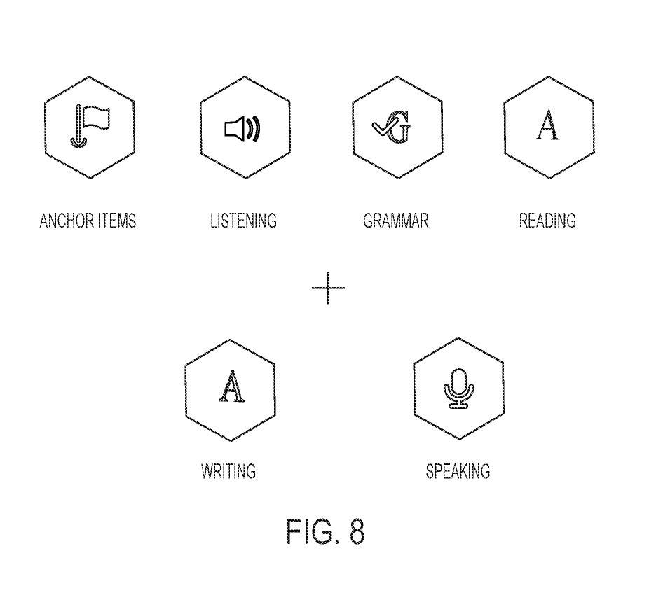

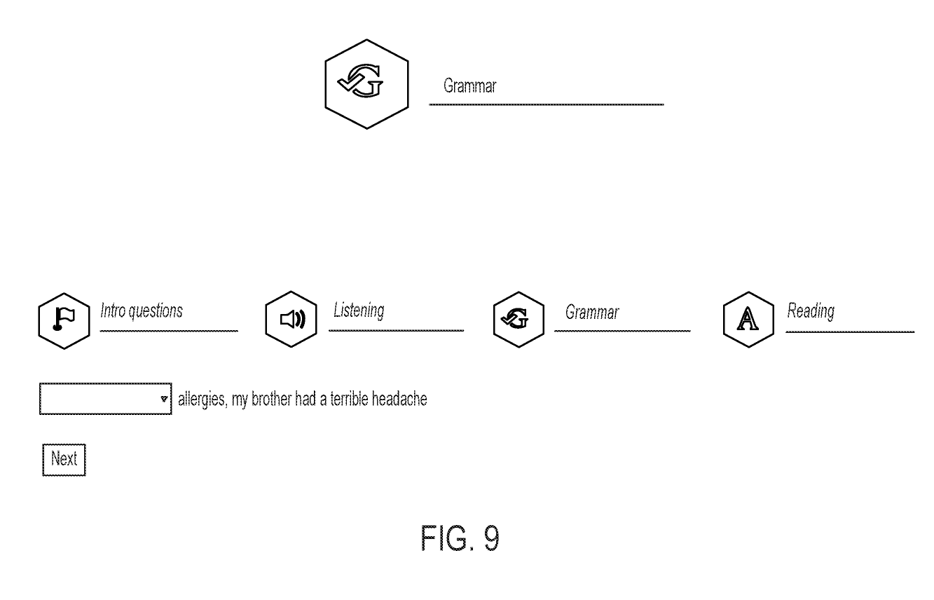

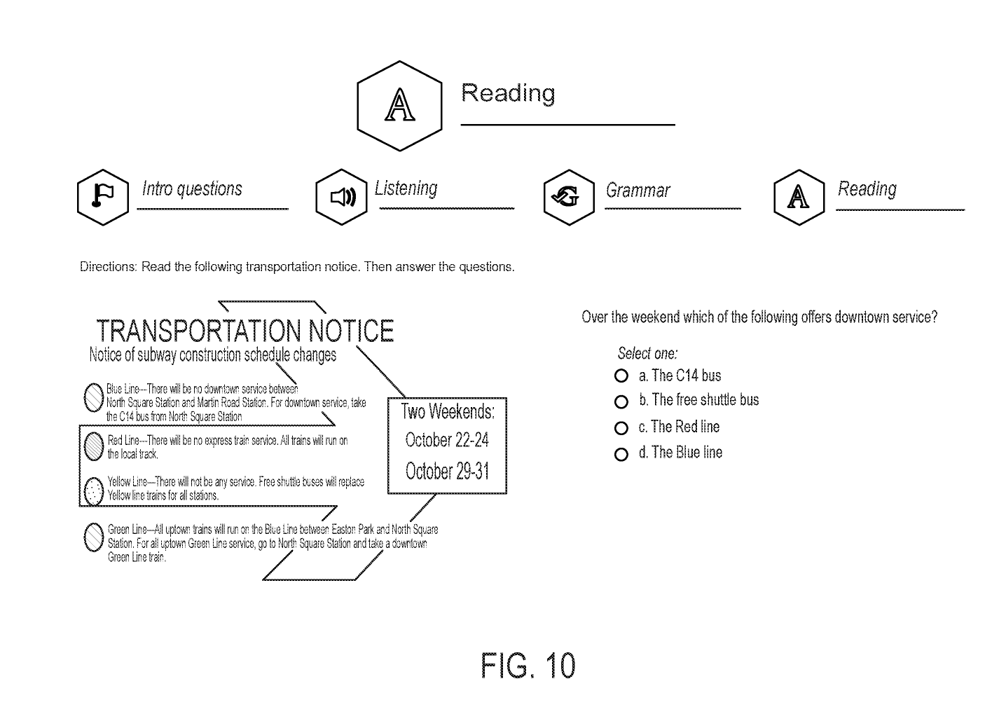

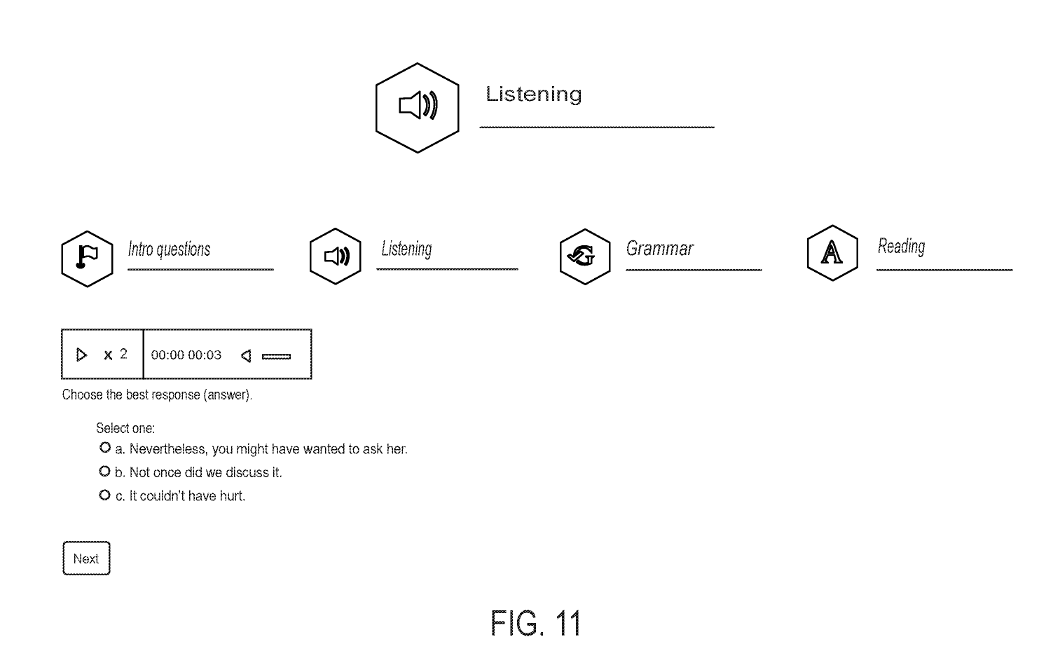

In an embodiment, for initial data, items, e.g., language skill questions, can be entered into an authoring tool, as a database to maintain questions. Question types can include multiple choice, fill in the blanks, matching, reading, writing, grammar, audio speaking/listening skills, and text response. FIGS. 8 to 11 show embodiments of different question types in a user interface. Questions can include metadata as to which skills the question is testing, including a particular region or location, vocabulary, level(s) of understanding and/or critical thinking Each question can have an initial scaling as to the level of difficulty associated with the question. Questions can be developed to match known language skills, including but not limited to simple present tense and simple past tense. Questions developed from the authoring tool can be held in a content management system, or item bank. Questions types can have one or more categories. For example, in grammar type questions, categories can include present perfect in advanced use, clauses, conditionals and wish statements, and comparatives and superlatives. A listening type question can have categories including listening as a member of a live audience, note-taking (lectures, seminars, etc.), and overall listening comprehension. The question types can have any number of categories and related to language assessment skills. FIG. 1 shows that questions and/or items can be developed to match areas of language skills.

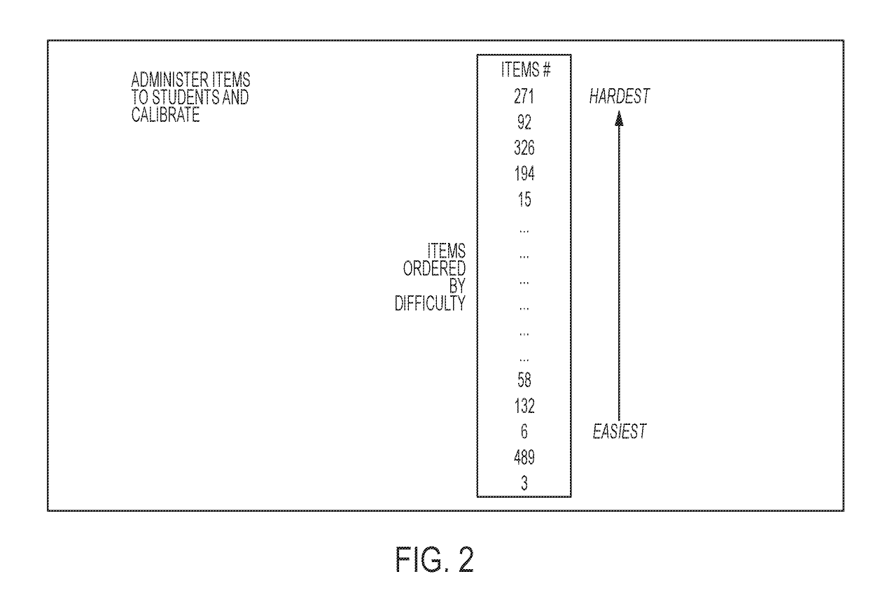

Questions are then calibrated by having a number of people answer them, as shown in FIG. 2. The answers can be aggregated to assess the difficulty level for each question. In an embodiment, an initial question can be uploaded to an authoring tool, and that, after receiving a specified number of responses, the question is calibrated. The question can be calibrated by assessing the level of difficulty based on the aggregated responses.

The question can be updated automatically based on the aggregated responses. The question can be automatically analyzed based on the aggregated responses. For example, if a question was initially assessing at a difficulty level, but based on responses received, the difficulty level can be updated. The question can continue to be automatically updated after any number of aggregated responses, so that the question is adaptively updated based on the aggregated data.

The questions can also be calibrated for additional parameters. For example, the questions can be calibrated based on question type.

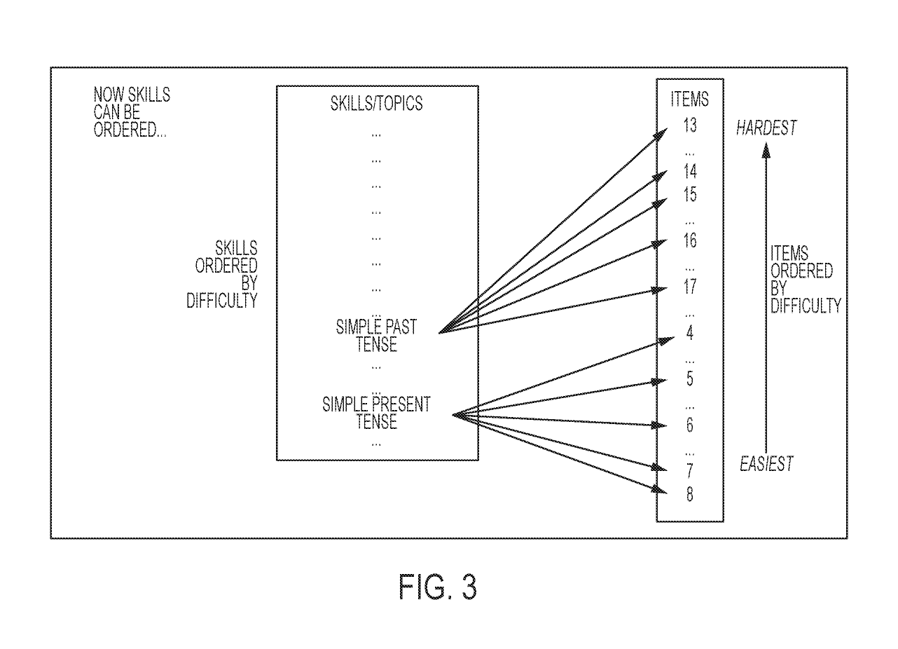

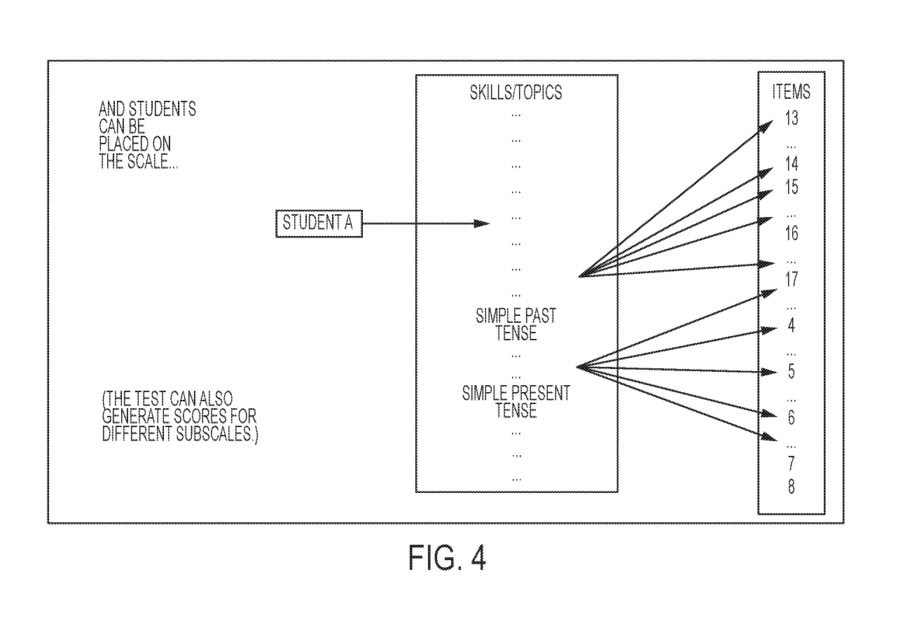

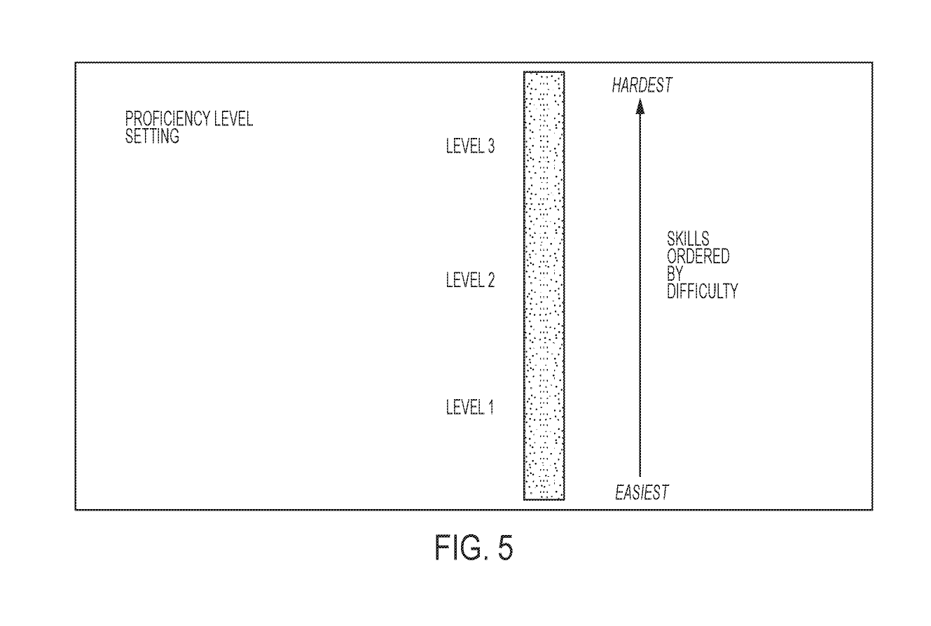

When the questions are calibrated to a level of difficulty, they can be ordered according to the calibrated level of difficulty, as shown in FIG. 3. Test takers can be included on the scale, as shown in FIG. 4, to indicate what level of proficiency based on the questions correctly answered at a level of difficulty. FIG. 5 shows one or more skill levels, depending on a level of difficulty to score test takers, which corresponds to the test taker proficiency level.

The content management system can store the questions, as well as the updated questions as data is received. The content management system can automatically review questions, providing a quality control review prior to providing the question to test takers. For example, the content management system can review questions spelling and grammar. The content management system can review the assigned level of difficult from the authoring tool. The content management system can update the questions to correct spelling and/or grammar, as well as adjust a difficulty level based on previously entered information. The content management system can also receive data from the test takers, and update stored questions based on the received information.

In an embodiment, a test taker can be given calibrated questions for a fixed initial assessment. That is, one or more questions are not yet adaptive. The answered questions can provide an initial determined ability and/or skills set. For example, the initial assessment can provide a determination of language skills. After the one or more questions are answered, the ability of the test taker can begin to be assessed by providing adaptive questions, as described below.

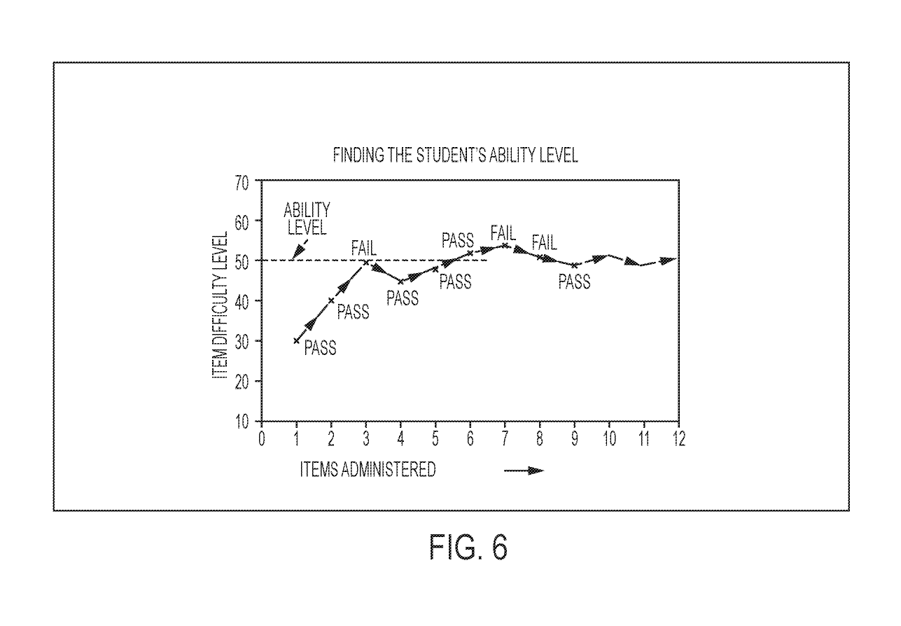

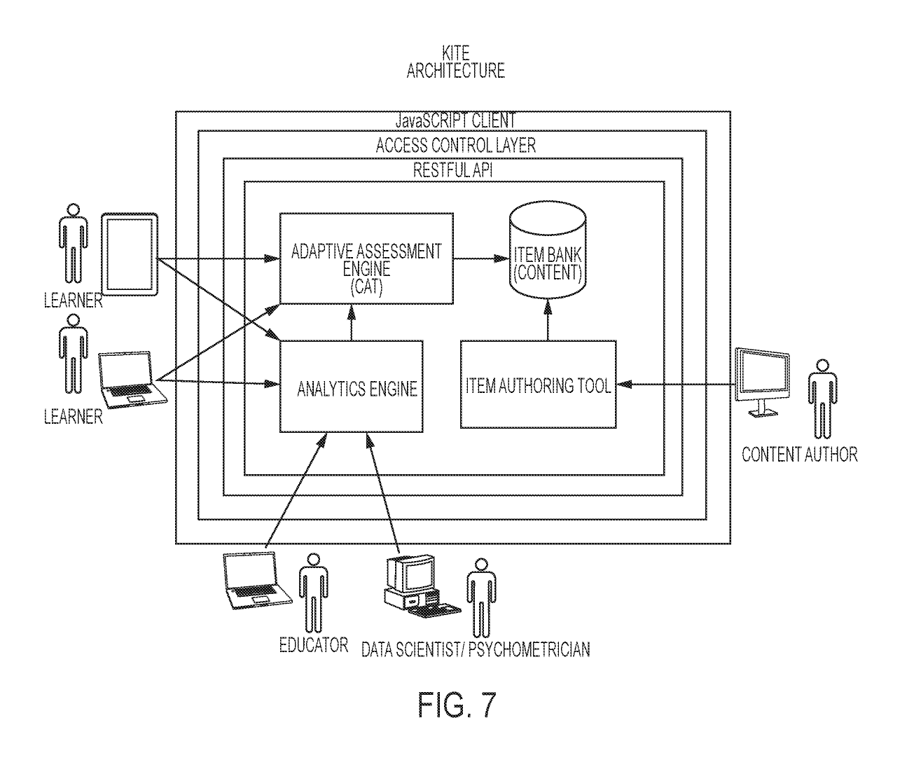

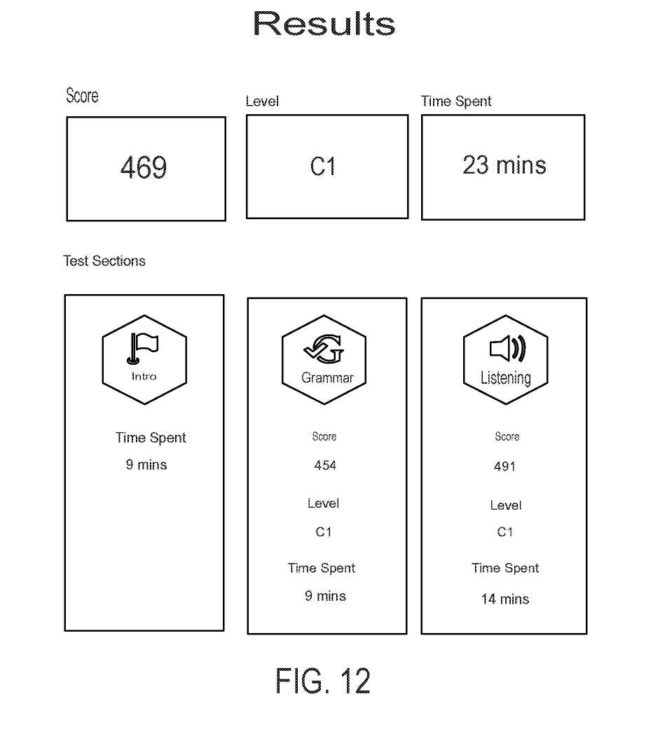

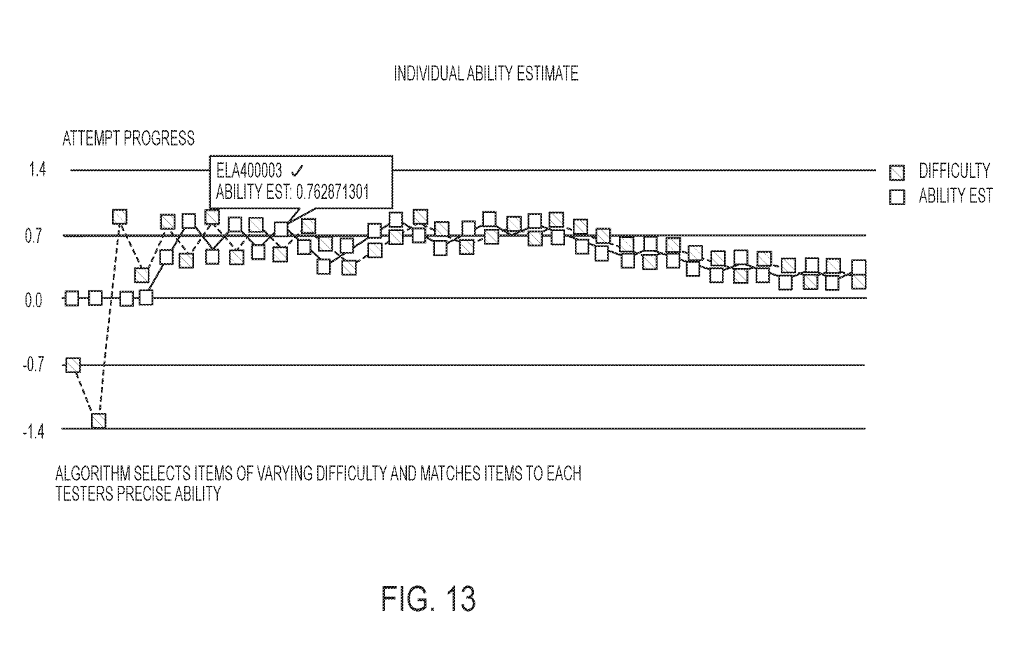

FIG. 7 shows an overview of the system. An Adaptive Assessment Engine is a system that is responsible for estimating a learner (test taker) ability and selecting items during an assessment. An Item Response Theory (IRT) algorithm provides the adaptive assessment engine with information during the assessment of a test taker. For example, a test taker begins an assessment by answering a question. FIGS. 8 to 11 show embodiments of a user interface of a skills test. The next question to answer depends on the answer of the first question. That is, if a test taker correctly answers a first question, the level of difficulty of the first question is assessed, and a second question is provided having a higher level of difficulty than the first question. If a test taker incorrectly answers a first question, then the second question can have the same or lower level of difficulty as the first question. For example, FIGS. 6 and 13 show a chart of questions provided and their difficulty level. As a question was correctly answered, or passed, the level of difficulty of the subsequent question increased. When a question is incorrectly answered, or failed, the level of difficulty of the subsequent question decreased. By providing questions responsive to a difficulty level, an assessment of the test takers skills and abilities can be determined. FIGS. 6 and 13 show for example an ability level is correlated with a difficulty level at which the test taker begins to incorrectly answer questions. FIG. 12 shows an embodiment of a user interface indicating the test results of a test taker. For example, the test results can indicate a proficiency level, a raw and/or scaled score, and the amount of time spent on the test. The results can also provide information such as time spent and raw/scaled score information for question types and/or categories of questions answered, so that a test taker can identify knowledge gaps.

In an embodiment, IRT item calibration provides evidence on validity of questions, and identifies problem questions to be discarded. For example, if a question contains information that is confusing or at an inappropriate skill level for test takers, the IRT algorithm can identify and discard the question from an assessment.

A test taker is assigned a proficiency, or ability level based on the assessment. The proficiency level can identify language skills of a test taker; the proficiency level can also indicate skills and/or knowledge gaps of the test taker. The proficiency level can correlate to language courses. The courses can be identified as providing specified skills and/or abilities. A test taker can be enrolled in a language course that satisfies missing skills and/or knowledge based on the proficiency level.

As test takers enroll and successfully finish courses, another assessment can be provided, ensuring that the skills and/or knowledge gaps have been filled, and their proficiency level adjusts according to their additional skills. For example, an Analytics Engine can be provided for tracking student progress, aggregating results, calibrating items, and making inferences based on estimates. The analytics engine can be utilized by both learners (test takers) and educators. Educators can view and enter information for students (e.g., learners and/or test takers). Educators can receive automated assessments of learners based on scores and determined proficiency levels. Educators can receive information of recommended courses to satisfy skills and/or knowledge gaps of students. For example, the analytics engine can aggregate assessments and analyze groups of learners. For example, a group of test takers can have an initial assessment. The test takers can take then a course meant to address skills and/or knowledge gaps identified by the initial assessment. At the end of the course, a secondary assessment can identify whether those gaps have been met. The secondary assessment can also analyze an educator's effectiveness. For example, the types of skills and/or knowledge tested can be analyzed to determine areas for educators to focus on in courses. Testing assessments can be linked to appropriate online study material, improving the rate and efficiency of student progress. The adaptive assessment of test takers can also lead to improved and/or more targeted courses for students to enroll in.

Advantages of the system and method include greater efficiency that existing testing, because it allows different students to be assessed by different questions but still be assessed on the same ability scale. Tests can be equated, so that test takers can be measured on language skills growth, and compare performance on different tests.

The assessment can be provided as an application, and/or a web-based user interface. The interface can be customized to a particular client. For example, the user interface can be customized to a school and/or university. Access for users and creators can be controllable. Clients could either upload students using a spreadsheet or integrate it with an existing Identity Provider (e.g., Active Directory, Google applications). The user interface can also be embedded in other existing applications. For example, a client can embed it into staff-training portals using the JavaScript library. RESTful API can also be utilized for implementation on mobile devices such as tablets, mobile computers, and mobile telephones.

Embodiments of the present invention provide for an adaptive assessment, which is driven by a modified or customized Item Response Theory (IRT) based engine. The customized engine estimates each student's or user's ability based on the user's responses to previous questions, and selects new items that best match the student's ability. This adaptive approach is more efficient than traditional fixed tests that present the same items to all students. In an embodiment, when a student finishes an adaptive assessment test, the system assigned a CEFR level for each section of the test, as well as an overall level. In an embodiment, the system can report on the skill strengths and skill weaknesses for each student. In an embodiment, the system provides a list of skills that the specific student needs to master in order to achieve the next level. In an embodiment, the list of skills can include references to or links to customized learning materials or other available references to assist a student in learning the respective skills. In an embodiment, the system can be customized for specific purposes. For example, items in a repository bank or database or other storage medium can be tagged for use in multiple levels and/or skills and/or purposes and in multiple testing contexts. For example, an item is tagged for placement and TOEFL test simulations, or for use only in specific regions such as Australia/New Zealand, United Kingdom, North America.

In embodiments, both adaptive and fixed tests can be created, and each section and item in a test can be customized to be timed or untimed. In an embodiment, a test administrator can set time or item number limits for tests and sections, and items can be filtered in various ways. For example, an item such as a long reading passage is filtered for use on a level test, but not on a placement test. In an embodiment, the system tracks a user's progress, through multiple testing events, and reports on the user's progress over the course of the user's studies. For example, when a student takes a placement test, the ability estimate from that placement test is used to select the initial terms on the next test the student takes, which might be a level test or other test. In an embodiment, for each new test a student takes, the test will remember the student's ability estimate from the previous test, e.g., stored in a database or other storage medium.

In an embodiment, a student's test scores over the course of time is made available to a manager or teacher. In an embodiment, a report is generated to show exactly how much each student has progressed on a point scale and on a level band scale. In an embodiment, a report is generated to show which skills the student has mastered and which skills need more work. In an embodiment, the test scored are exported into .csv or .doc or other format files, and can be given to students as a comprehensive progress report for their course of study.

In an embodiment, the global curriculum implemented is a comprehensive framework that combines the listening, reading, writing, spoken production, and spoken interaction “can do” descriptors. Each descriptor is broken down to define skills, subskills, text type, Flesch-Kincaid readability, and a variety of different characteristics associated with the specific level of the descriptor. In an embodiment, the CEFR or EAQUALS descriptors and/or levels are used.

In an embodiment, the system reports an overall score for the assessment of a student, as well as scores for each skill section. The overall score is calculated by a formula that analyzes performance on every item of the assessment. The overall scores can be reported in a range of 0 to 700. In an embodiment, the individual skill section scores are calculated based only on performance within each skill section. Each individual skill section is also scored in a range of 0 to 700. Unlike many traditional assessments, the overall score of the embodiment is not a sum or average of the individual skill section scores. The assessment gathers information and analyzes overall performance and individual skill performance effectively simultaneously.

In an embodiment, when the system recommends skill enhancements, such recommendations might be to watch the nightly news and take notes about the main facts, or to leave a voicemail message for yourself describing an event to build fluency. In an embodiment, because skill recommendations are generated based on actual student performance data, students can receive receive recommendations for skills that are above or below their overall CEFR level.

In an embodiment, an administrator of the system can have a variety of different abilities to modify and/or maintain the system, including, e.g., log-in, authentication control, user lockout, change password, edit profile, filter by tenant, attempt tracker, filter by username or name, filter by last attempt date, filter by category, filter by user status, filter by locked users, export to csv file, view student attempt records, edit user, switch user, add new user manually or by batch, general view, dashboard view, detailed view, remove attempt, manage tenants, assessment list, copy assessment, assessment users, add new assessment, overall assessments settings and management, assessment section settings, fixed sections, adaptive sections including option to select only non-grouped items, section directions, choose skill, sub-skill filter, skill-tag filter, minimum number of items in section, maximum number of items in section, and item seeder for uncalibrated items. Further functions can include: management of productive sections, assessment password, assessment reports, item bank, item bank filter, add new items, multiple choice item, cloze item, group item, writing/speaking item, region manger, levels manager, skill settings, add new skill, skill tag settings, and add skill tag, among others.

In an embodiment, a modification of an IRT algorithm is used. In an embodiment, IRT variables include assessing difficulty, discrimination, and guessing. In an embodiment, testing includes selected responses, constructed responses, and MMC uploads, and a layout type including themes of horizontal, vertical, icons/text, determinations is involved in the adaptive learning environment. In an embodiment, a determination regarding ability estimation using a conditional maximum likelihood estimate is provide. For example, in the IPL case, ability estimation begins with an initial estimation of Θₘ based on the item response vector.

### Step 1:

Θₘ=ln[rₐ/(n−rₐ)] (1)

where rₐ=Σaᵢuᵢₐ
where n is the total number of items, aᵢ is the discrimination parameter for item i, and uᵢₐ is the response (1 or 0) to item i by subject a. Note that when aᵢ is fixed at 1 for all items, as is the case with the IPL model, Σaᵢuᵢₐ reduces to Σuᵢₐ which is equal to the number of correct responses and (n−rₐ) is equal to the number of incorrect responses.

### Step 2:

From this starting value compute ΣPᵢ and ΣPᵢQᵢ using the appropriate probability function, which in the case of the 1PL model is:

P(1|Θ)=e^{(Θ-δ)}/(1+e^{(Θ-δ)}) (2)

### Step 3:

Compute the correction factor h₀ using the following equation

h₀=D [r−Σ Pᵢ(Θₘ)]/[−D²ΣPᵢ(Θₘ)Q(Θₘ)] (3);

where D is a scaling constant of 1.7. This can be removed or set to 1. This formula is equivalent to the first derivative of the logarithm of the likelihood function divided by the second derivative of the logarithm of the likelihood function.

For the 2PL case, the first derivative of the logarithm of the likelihood function is:

DΣaᵢ(uᵢₐ−Pᵢₐ) (4)

where uᵢₐ is the response to item i by subject a and Pᵢₐ is the probability of responding correctly to item i by subject a according to the 2PL probability function, and aᵢ is the discrimination parameter for item i.
and the second derivative of the logarithm of the likelihood function is:

−D²Σaᵢ²Pᵢₐ(1−Pᵢₐ) (5)

thus, in the 2PL case,

h₀=DΣaᵢ(uᵢₐ−Pᵢₐ)/−D²Σaᵢ²Pᵢₐ(1−Pᵢₐ) (6)

For the 3PL case, the first derivative of the logarithm of the likelihood function is:

DΣ aᵢ(uᵢₐ−Pᵢₐ)(Pᵢₐ−cᵢ)/Pᵢₐ(1−cᵢ) (7)

where cᵢ is the guessing parameter for item i
and the second derivative of the logarithm of the likelihood function is:

D²Σaᵢ2(Pᵢₐ−cᵢ)(uᵢₐci−Pᵢₐ²)Qᵢₐ/Pᵢₐ²(1−cᵢ)² (8)

thus, in the 3PL case,

h₀=DΣ aᵢ(uᵢₐ−Pᵢₐ)(Pᵢₐ−cᵢ)/Pᵢₐ(1−cᵢ)/D²Σaᵢ²(Pᵢₐ−cᵢ)(uᵢₐcᵢ−Pᵢₐ²)Qᵢₐ/Pᵢₐ²(1−cᵢ)² (9)

Notice when cᵢ=0, the 3PL equation reduces to the 2PL equation, and when cᵢ=0 and aᵢ=1 the 3PL equation reduces to the 1PL equation.

### Step 4:

Compute the new value of Θₘ₊₁=Θₘ−h₀.

### Step 5:

Repeat calculations in STEPS 2-4 until such time that h₀ is sufficiently small (i.e., <0.001) wherein iterations terminate and Θₘ is used as the estimate for Θ, i.e., in an embodiment, the ability estimate.

In an embodiment, a determination of standard error is made in order to determine when to allow a user to progress. For example:

The calculation of the information function I(Θ) involves the second derivative of the item response function with respect to Θ. For the IPL model the equation for I(Θ) is:

I(Θ)=ΣD²PᵢQᵢ (10)

For the 2PL model, the equation for I(Θ) is;

I(Θ)=ΣD²aᵢ²PᵢQᵢ (11)

and for the 3PL model the equation for I(Θ) is;

I(Θ)=ΣD²aᵢ²Qᵢ(Pᵢ−cᵢ)²/(1−cᵢ)²Pᵢ (12)

Notice when cᵢ=0, the 3PL equation reduces to the 2PL equation, and when cᵢ=0 and aᵢ=1 the 3PL equation reduces to the 1PL equation.

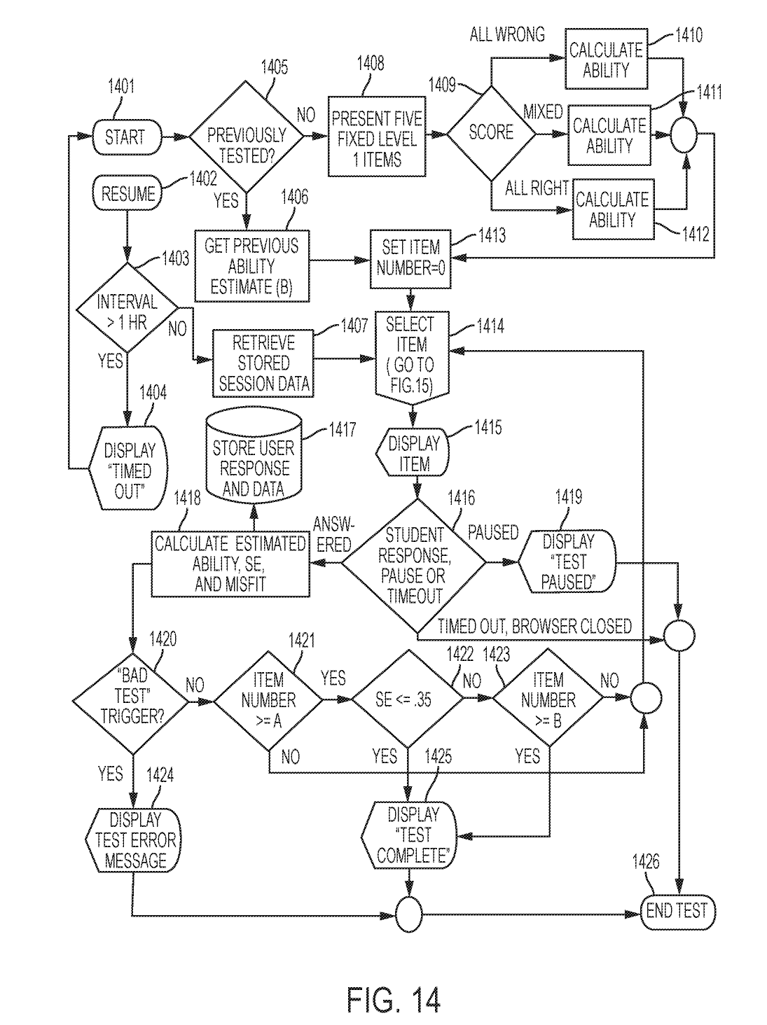

In all three IRT models, the standard error of the maximum likelihood ability estimate is [I(Θ)]^{-1/2}, which is the reciprocal of the square root of the information function.

[71] In FIGS. 14 to 25, example embodiments of various processes carried out by the present invention are demonstrated.

[72] In FIG. 14, an example embodiment of an adaptive testing is demonstrated. The process starts 1401 and determines, e.g., via user interface popup question or a check in a database associated with the user's records, whether the user has been previously tested 1405. If the system or the user inputs that the user has been previously tested, then the system obtains 1406 the previous ability estimate stored in the system, in a storage area or other location or input, and sets item number equal to zero 1413. If, at 1405, the system or the user inputs that the user has not been previously tested, then five fixed Level 1 items are presented 1408. For example, the five fixed Level 1 items are five basic or entry level questions used for determining an initial skill level of a user. The answers inputted by the user are then scored 1409. The scoring can be calculated simply by a right or wrong per question, so that all wrong is five questions answered incorrectly according to, e.g., a lookup table, mixed results is some answered correctly and some answered incorrectly, and all right is all five questions answered correctly. In each case, the user's ability is calculated 1410, 1411, 1412. In an embodiment, there can be a different initial assessment with less or more than five questions. In an embodiment, the initial assessment can include at least one of a multiple choice question, a question requiring a natural language input, and a true/false question. After calculating the ability of the new user 1410, 1411, 1412, the system sets the item number equal to zero 1413.

After 1413, the item is selected 1414, e.g., by the system based on the previous ability estimate obtained 1406 or the calculated ability 1410, 1411, 1412. For example, the item is selected by a user or an administrator. For example, an item can be at least one of a question, a series of questions, a sound recording, a visual piece, and a literary passage. The item is then displayed 1415, e.g., on a computer monitor or display screen, mobile device screen, television screen, or other display device. Upon display 1415, there is either an input option for the user's response or a pause, or a system timeout 1416. If the system is paused, then the display device will indicate that the test is paused or another indication 1419, and the test session is then ended 1426. In an embodiment, each time the user inputs into the system, the value is recorded in a database or other storage medium. In an embodiment, when the test session is paused, the system records the last inputs by the user or the system including at which point during the testing session that the test session is paused. In an embodiment, if the system records or stores information regarding when the test session is paused, then upon the user entering a new test session, the system recalls the point at which the test session was paused and allows the user to continue as if the test session was effectively not paused. In an embodiment, if the system times out due to a nonresponse by the user, or system failure, or other event, then the browser is closed and the test session ends 1426. If the student answers the item(s) or question(s), then the system calculates an estimated ability based on the user's response(s) 1418. In an embodiment, the system also calculates the estimated standard error, and makes a determination based on the user's response and/or other users' responses to the same, if the items or questions are misleading or in some way not useful 1418. The user's response(s), data, and the calculated ability are stored in a storage medium 1417. At 1420, if the items or questions are determined to be not useful, a “bad test” trigger is activated and an error message is displayed to the user 1424. The test session then ends 1426. At 1420, if the “bad trigger” is not activated and the items or questions are not determined to be not useful, then the item number is compared to a set variable A. The set variables A and B can be predetermined threshold values inputted by an administrator for the system. If the item number is greater than or equal to A 1421, then the standard error is determined and compared to a set value, e.g., 0.35 1422. If the item number is less than A 1421, then the user is given another item or question to answer 1414, and the process is continued. For example, A can be the number of questions or items answered during a test session. If the standard error is determined to be less than or equal to a predetermined value 1422, then the display indicates that the text is complete 1425, and the test session ends 1426. If the standard error is determined to be greater than a predetermined value 1422, then the system checks whether the item number is greater than or equal to B 1423. If not, then the user is brought back to selecting an item 1414. If so, then the display indicates that the test is complete 1425 and the test session ends 1426.

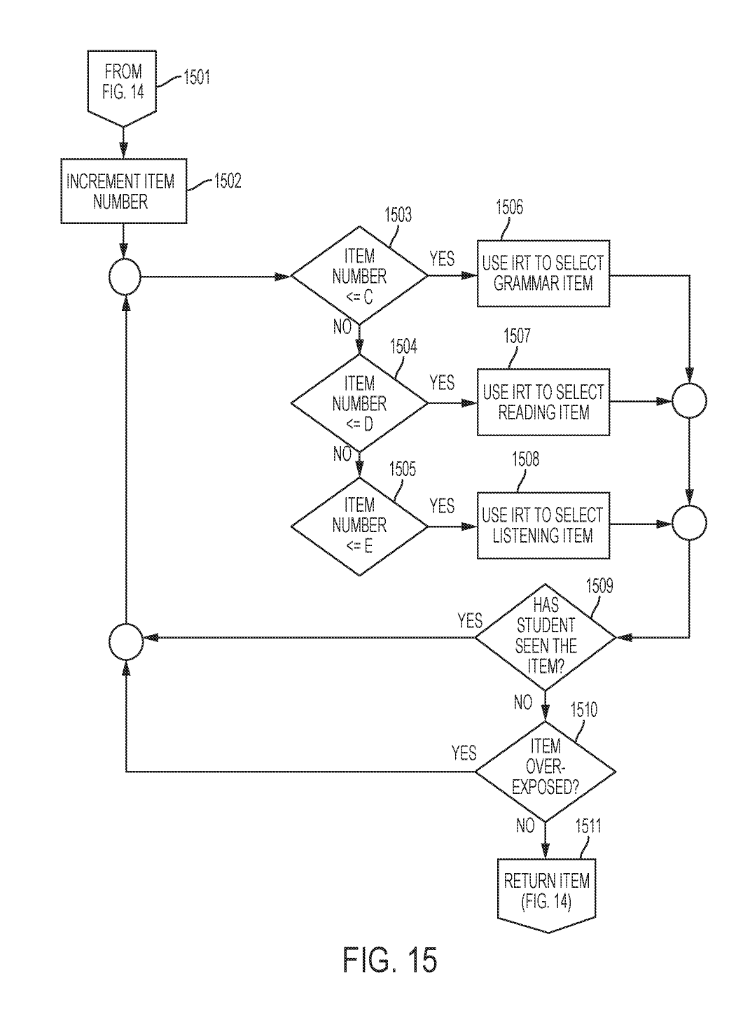

FIG. 15 shows an example test session flowchart, describing what occurs, e.g., in FIG. 14 at 1414 when an item is selected 1501. The item number is incremented 1502. The item number is there compared to value C to determine whether the item number is less than or equal to C 1503. If yes, then the modified IRT algorithm of the present invention is used to select a grammar item (or other item, depending upon the focus on the test session) 1506. Then, the system determines whether the student has seen the item or question 1509. If yes, then the comparison of the item number to C at 1503 occurs again. If no, then the system determines whether the item or question is overexposed 1510. For example, overexposure refers to users or test takers seeing an item a certain numbers of times. If the item or question is seen a certain number of times, e.g., 5,000 times, then the system will retire the use of that item for a defined length of time. For example, an overexposure threshold is set at X in advance so that when an item is used X times, then the item is no longer used. In an embodiment, the system can check this via a lookup table or other mode. At 1510, if yes, then the comparison of the item number to C at 1503 occurs again. At 1510, if no, then the system returns 1511 the item to FIG. 14 at 1414. In an embodiment, if the item number is determined to be greater than C 1503, then the item number is compared to a value D 1504. If the item number is greater than D 1504, then the IRT is used to selected reading item 1507, and the progressed to 1509. If the item number is determined to be greater than D, then the item number is compared to value E 1505. If the item number is greater than E, then a modified IRT is used to selected a listening item 1508. If the item number is less than or equal to E 1505, then the system sends an error message. For example, one or more of the values C, D, E can be predetermined set values, values that modify overtime depending upon certain circumstances, or dynamically inputted values. In an embodiment, the overexposure query is not implemented. In an embodiment, the item number is compared to various variable and/or set values.

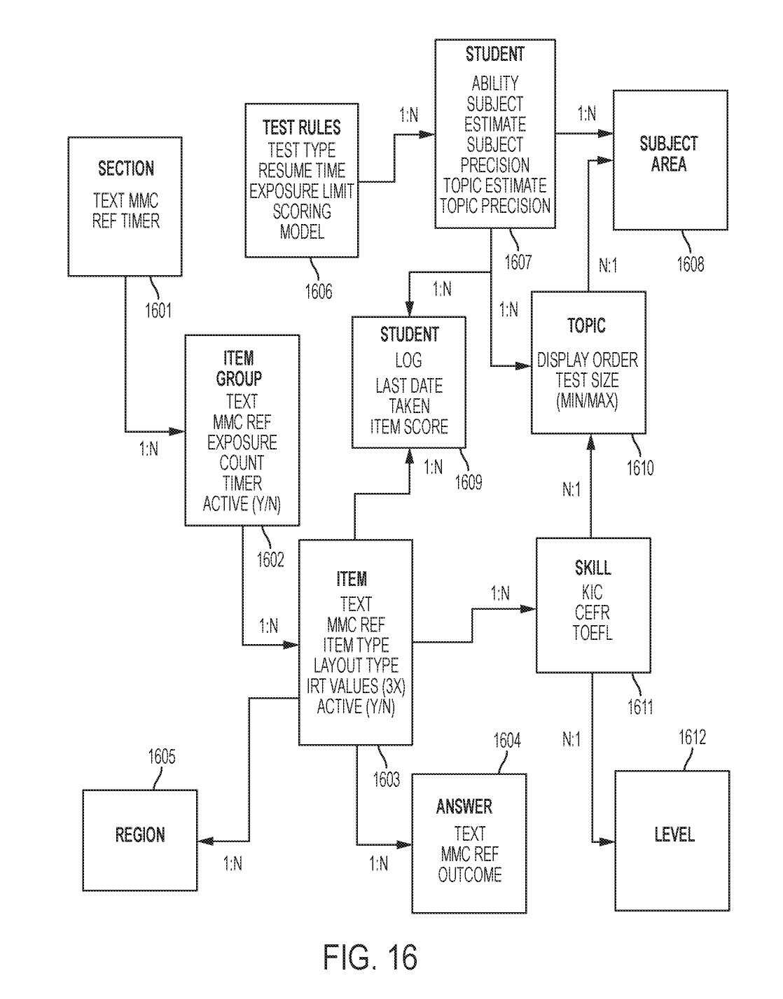

In FIG. 16, an example items data model is shown. For example, various item data are obtained, produced, and/or stored, such as at least one of: section data 1601 including, e.g., text, MMC reference, and a timer; item group data 1602, including, e.g., text, MMC reference, exposure, count, timer, and status; item data 1603, including, e.g., text, MMC reference, item type, layout type, IRT values(3x), and status; answer data 1604, including, e.g., text, MMC reference, and outcome; region data 1605; test rules data 1606, including, e.g., test type, resume time, exposure limit, and scoring model; student data 1607, including, e.g., ability, subject estimate, subject precision, topic estimate, topic precision; subject area data 1608; student log data 1609, including, e.g., last date taken, and item score; topic data 1610, including, e.g., display order, test size (minimum/maximum); skill data 1611, including, e.g., skill data from Kaplan™, CEFR, and TOEFL; and level data 1612.

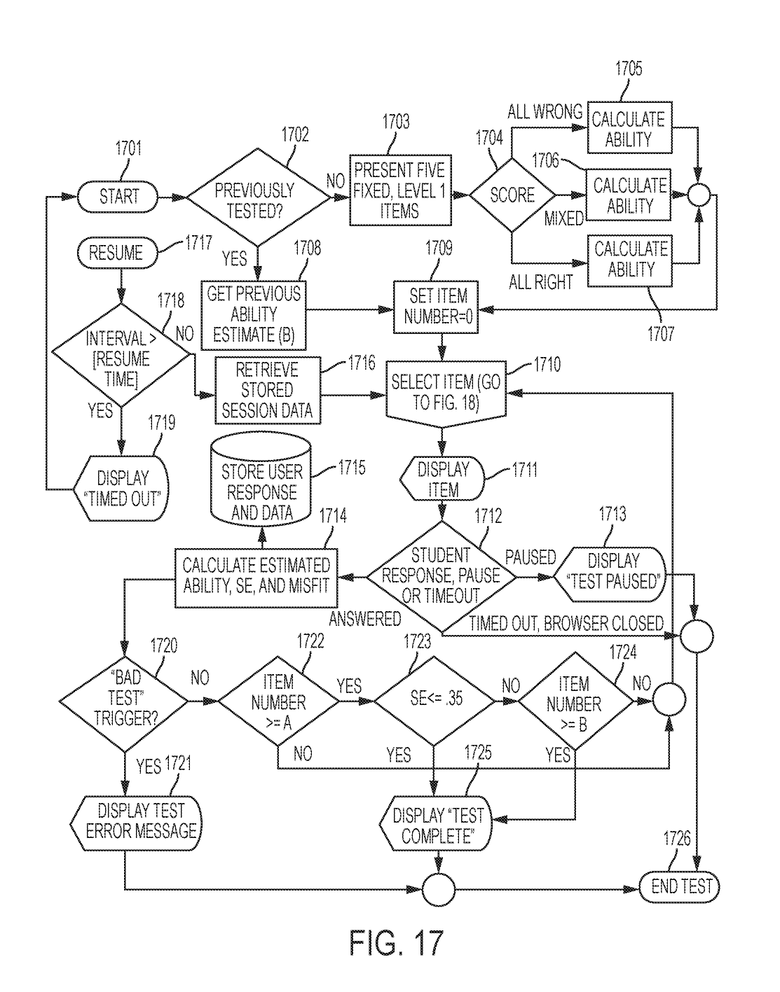

In FIG. 17, an example embodiment of an adaptive testing is demonstrated. The process starts 1701 and determines, e.g., via user interface popup question or a check in a database associated with the user's records, whether the user has been previously tested 1702. If the system or the user inputs that the user has been previously tested, then the system obtains 1708 the previous ability estimate stored in the system, in a storage area or other location or input, and sets item number equal to zero 1709. If, at 1702, the system or the user inputs that the user has not been previously tested, then five fixed Level 1 items are presented 1703. For example, the five fixed Level 1 items are five basic or entry level questions used for determining an initial skill level of a user. The answers inputted by the user are then scored 1704. The scoring can be calculated simply by a right or wrong per question, so that all wrong is five questions answered incorrectly according to, e.g., a lookup table, mixed results is some answered correctly and some answered incorrectly, and all right is all five questions answered correctly. In each case, the user's ability is calculated 1705, 1706, 1707. In an embodiment, there can be a different initial assessment with less or more than five questions. In an embodiment, the initial assessment can include at least one of a multiple choice question, a question requiring a natural language input, and a true/false question. After calculating the ability of the new user 1705, 1706, 1707, the system sets the item number equal to zero 1709.

After 1709, the item is selected 1710, e.g., by the system based on the previous ability estimate obtained 1708 or the calculated ability 1705, 1706, 1707. For example, an item is selected by a user or an administrator. For example, an item can be at least one of a question, a series of questions, a sound recording, a visual piece, and a literary passage. The item is then displayed 1711, e.g., on a computer monitor or display screen, mobile device screen, television screen, or other display device. Upon display 1711, there is either an input option for the user's response or a pause, or a system timeout 1712. If the system is paused, then the display device will indicate that the test is paused or another indication 1713, and the test session is then ended 1726. In an embodiment, each time the user inputs into the system, the value is recorded in a database or other storage medium. In an embodiment, when the test session is paused, the system records the last inputs by the user or the system including at which point during the testing session that the test session is paused. In an embodiment, if the system records or stores information regarding when the test session is paused, then upon the user entering a new test session, the system recalls the point at which the test session was paused and allows the user to continue as if the test session was effectively not paused. In an embodiment, if the system times out due to a nonresponse by the user, or system failure, or other event, then the browser is closed and the test session ends 1726. If the student answers the item(s) or question(s), then the system calculates an estimated ability based on the user's response(s) 1714. In an embodiment, the system also calculates the estimated standard error, and makes a determination based on the user's response and the difficulty level of the question, as determined by the calibration testing, if the items or questions are misleading or in some way not useful 1714. The user's response(s), data, and the calculated ability are stored in a storage medium 1715. At 1720, if the items or questions are determined to be not useful, a “bad test” trigger is activated and an error message is displayed to the user 1721. The test session then ends 1726. At 1720, if the “bad trigger” is not activated and the items or questions are not determined to be not useful, then the item number is compared to a set variable A. If the item number is greater than or equal to A 1722, then the standard error is determined and compared to a set value, e.g., 0.35 1723. If the item number is less than A 1722, then the user is given another item or question to answer 1710, and the process is continued. For example, A can be the number of questions or items answered during a test session. If the standard error is determined to be less than or equal to a predetermined value 1723, then the display indicates that the text is complete 1725, and the test session ends 1726. If the standard error is determined to be greater than a predetermined value 1723, then the system checks whether the item number is greater than or equal to B 1724. If not, then the user is brought back to selecting an item 1710. If so, then the display indicates that the test is complete 1725 and the test session ends 1726.

In an embodiment, if a user has paused the system or the system logs out the user, the system can resume 1717 the test session. The interval is then compared to an interval 1718. If the interval is greater than the resume time, then the display is timed out 1719 and the user is directed to the start of the flow at 1710. If the interval is not greater than the resume time, then the system retrieves stored session data 1716, and the user is directed to selecting an item 1710.

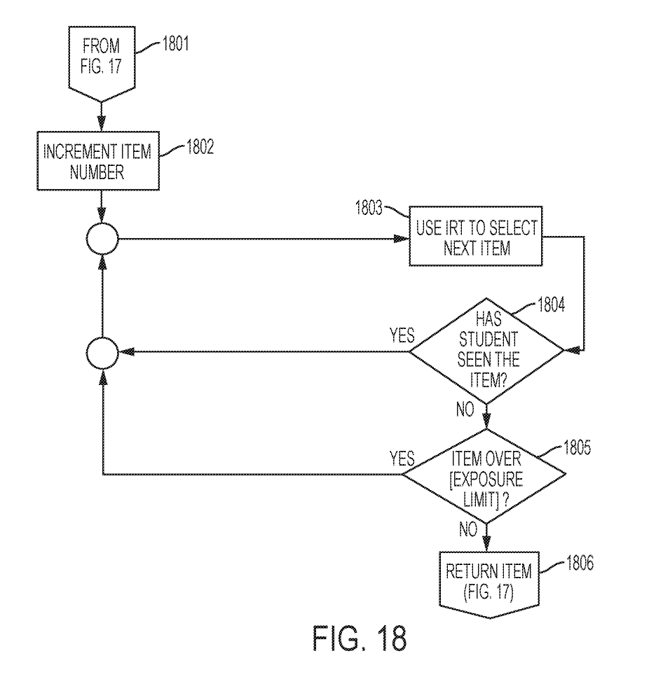

FIG. 18 shows an example test session flowchart, describing what occurs, e.g., in FIG. 17 at 1710 when an item is selected 1801. The item number is incremented 1802. The modified IRT is used to select the next item 1803. Then, the system determines whether the student has seen the item or question 1804. If yes, then the modified IRT is used to select the next item 1803. If no, then the system determines whether the item or question is overexposed 1805. If yes, then the modified IRT is used to select the next item 1803. If no, then the system returns 1806 the item to FIG. 17 at 1710.

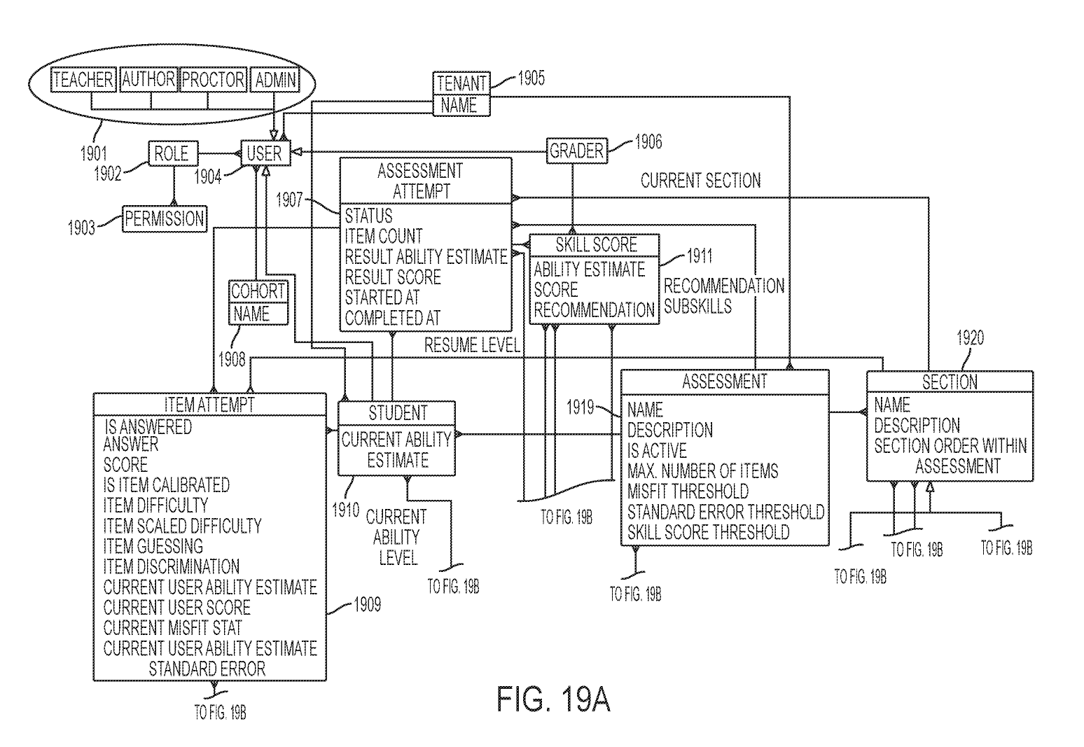

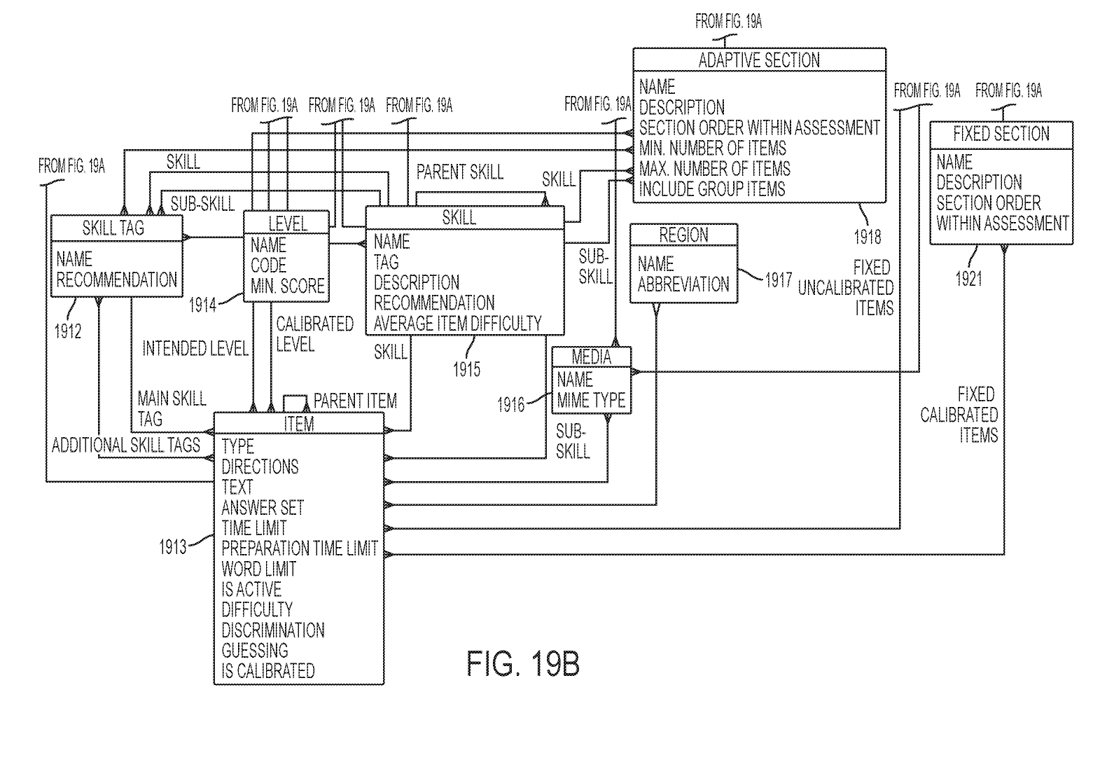

FIGS. 19A and 19B show an example backend process according to an embodiment of the present invention. For example, at 1901, the user who might be a teacher, an author, a proctor, or an administrator enters the system as a user 1904. The computer system determined the role 1902 of the user, and authenticate the necessary permission or authentication 1903. For identification, the user inputs either manually a name or identification, inserts a thumb or other personal item into a biometric reader, scans an identification card or bar code or identification information. A cohort 1908 is a group of users. In an embodiment, a cohort is set by each tenant, and a user can be assigned to multiple cohorts. The tenants or tenant managers can run score reports on the cohort of users so that they can analyze the data on different users of the cohort or of different cohorts and track performance. The user, if a tenant or user of the system 1905, is checked against the stored records for students 1910, if one exists, in order to determine current ability estimate. Or, if new, the user is invited to answer questions or respond to items, as described in embodiments above, in order that a current ability estimate can be determined 1910. The item attempt 1909 information stored includes whether the item is answered, is an answer at all, is scored, whether item is calibrated, notes the item's difficulty and scaled difficulty in relation to other items, item guessing information, item discrimination, current user ability estimate, current user score, current misfit statistic, and current user ability estimate standard error. An assessment 1919 of a user or tenant, is determined and/or stored by the system. For the assessment 1919, at least one of the following is stored or noted: name, description, active status, maximum number of attempts at answering one or more items, misfit threshold, standard error threshold, and skill score threshold. In an embodiment, misfit is set to determine whether or not a student is answering randomly or guessing. This extra measure for misfit is employed to prevent cheating. In an embodiment, when misfit is determined by the system, the system stops the test and sends it to error status. In an embodiment, based on the item's specific modified-IRT parameters and the student's (or user's) ability, a probability function is calculated determining the probability that the student will answer correctly and then based on the student's score and the item's probability, the system calculates misfit for that item. And, in an embodiment, based on all of the items from a given attempt, the system calculates the misfit. For an assessment, information regarding assessment attempts 1907 is considered. For an assessment attempt 1907, at least one of the following is stored or noted: status, item count, result ability estimate, result score, time or item or level started at, and time or item or level completed at. In an embodiment, for an assessment attempt, the level 1914 is referenced or accessed and noted, including name, code and minimum score. Associated with an item 1913 and its level 1914 is a skill tag 1912 which includes a name and recommendation. For an item 1913, at least one of the following is stored or noted: type, directions for the item, text of the item, answer set associated with the item, predetermined time limit allowed for the item (which varies depending upon the associated skill 1915), preparation time limit for the item, word limit, active status, difficulty assessed of the item, discrimination, guessing chances noted (e.g., in the case of multiple choice or true/false, check whether the preceding and following answered items have a pattern of answer indicating guessing), and calibration. Each item 1913 is associated with skill tags 1912 which identify a skill or sub-skill information of the skill 1915. For a skill 1915, at least one of the following is stored or noted: skill name, skill tag, description of skill, recommendation, and average item difficulty level. Each item 1913 can be associated with a region 1917, including a name abbreviation of the geographical region, and a media type 1916 which includes a name and/or MIME type. For each section 1920 tested or training with a user, at least one of the section name, section description, and section order within the assessment is stored or accessed. Each section can have an adaptive section 1918 and a fixed section 1921. The fixed section 1921 includes at least one of a section name, description, and relative section order within an assessment. The adaptive section 1918 includes at least one of a section name, description, relative section order within an assessment, minimum number of items, maximum number of items, and an indication of group items or group items included. For each user 1904, a grader 1906 is associated, the grader 1906 concerning the user's associated skill score 1911. For each user 1904, it is noted whether the user is a student 1910 having a current ability estimate and/or level. In FIGS. 19A and 19B, the various stored example fields and/or information kept or accessed by an embodiment of the present invention are shown. There are links or associations between various fields or data entries.

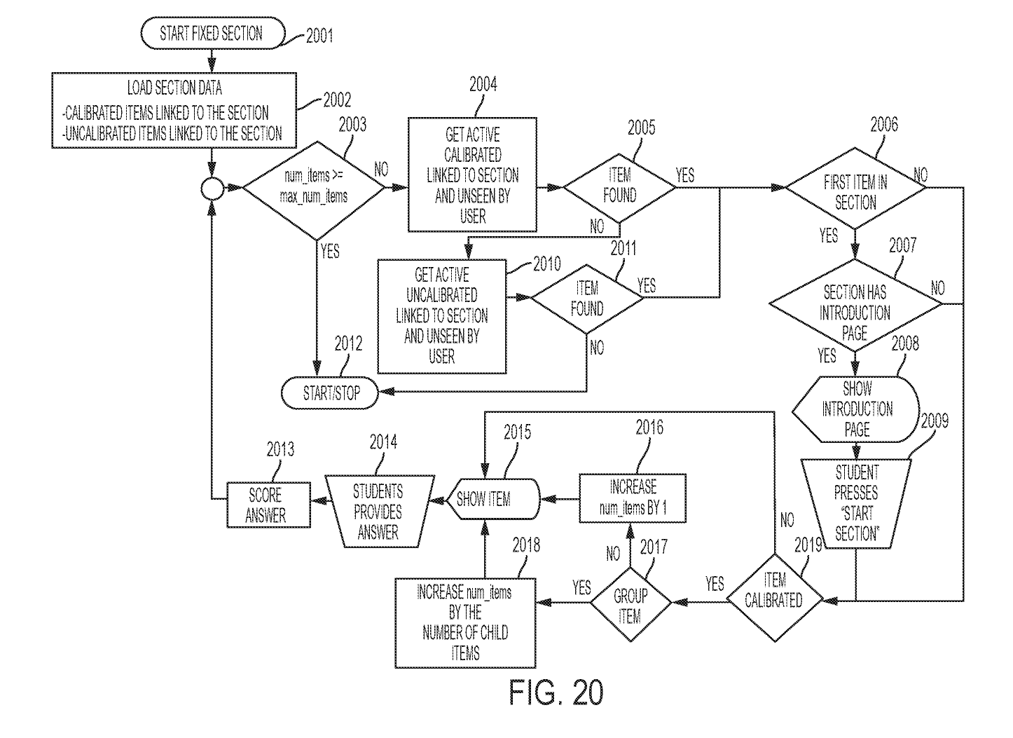

FIG. 20 shows an example backend process regarding a specific section being tested on a user. For example, a fixed section is started 2001. The section data is loaded 2002, including calibrated items linked to the section and uncalibrated items are linked to the section. The system checks whether the number of items is greater than or equal to the maximum number of items 2003 for the section. If yes, then the section review ends 2012. If no, then the system gets an active calibrated item linked to the section and relatively unseen by the user 2004. If the active calibrated item is found 2005, then it is checked whether the active calibrated item is the first item in the section 2006. If yes, then the section checks for an introduction page 2007. If yes, then the introduction page is shown 2008, and the student can then press “start section” or other indicator 2009 in order to start a test or training session. If the active calibrated item is not found 2005, then the system gets an uncalibrated item linked to the section and relatively unseen by a user 2010. It is then checked whether the item is found 2011, and if no, the test or training session stops 2012. If yes, then the processes starting at 2006 are effected.

At 2006, if it is determined that the item found is not a first item in the system, then the system checks whether the item is calibrated 2019. If calibrated 2019, then the system checks if the item is part of a group item 2017 (e.g., a series of questions linked for level purposes, or common text or theme purposes, etc.). If yes, then the number of items field is increased by the number of child items to account for the group 2018. If no, then the number of items field is increased by 1. In each case, the item can then be shown 2015 in the system display to a user, a student can provide an answer 2014, the answer is scored 2013, and the system continues.

At 2007, if the section does not have an introduction page to show, then the system checks whether the item is calibrated 2019.

At 2019, if the system determines that the item is not calibrated 2019, the item is shown 2015, the student provides an answer 2014, and the answer is scored 2013, and the system continues 2003.

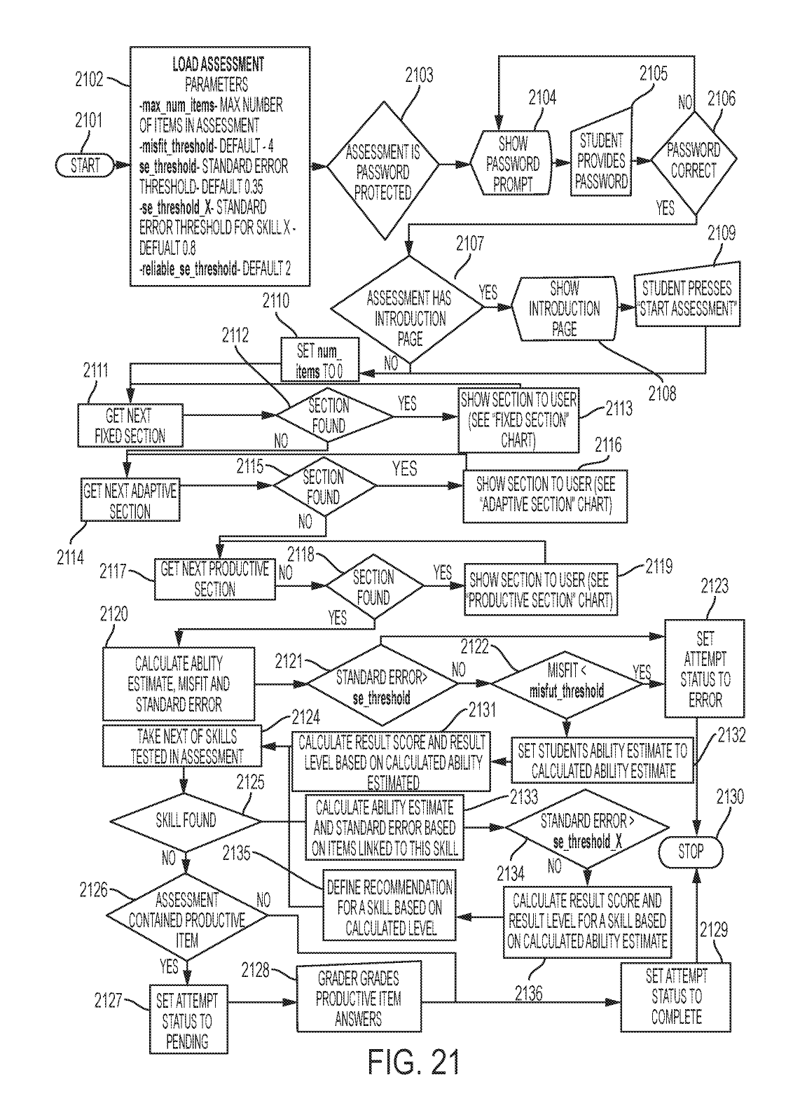

FIG. 21 shows an example backend process of an embodiment of the present invention. For example, the system starts at 2101, and assessment parameters are loaded 2102. The assessment parameters loaded 2102 include at least one of a maximum number of items in the assessment, a misfit threshold, a standard error threshold, a standard error threshold for a specific skill, and a reliable standard error threshold. The assessment parameters loaded 2102 can include set default thresholds. For example, a misfit threshold default can be −4; a standard error threshold defaults can be 0.35; a standard error threshold for a specific skill can be 0.8; and a reliable standard error threshold default can be 2. These parameters can be set by an administrator to be other values. An assessment is password protected 2103, and the values are stored by the system. A password prompt 2104 is shown and a user enters a password 2105. The password is checked against the stored value in the system 2106, and if not a match, the user is again provided with a password prompt to enter the password and try again 2104. If the password is a match 2106, then an introduction page of the assessment is checked for in the system 2107. If there is an assessment page 2107, then the introduction page is shown or displayed to the user 2108, and the user is provided with an option to start the assessment testing session 2109. If no at 2107, or if at 2109 the user starts the assessment testing session, then the number of items value field is set to zero 2110. The system gets the next fixed section 2011, the system checks whether the system is found 2112, and if yes, the section is shown to the user 2113, and the system gets the next fixed section 2111. At 2112, if the section is not found, then the system gets the next adaptive section 2114. If the adaptive section is found 2115, then the adaptive section is shown to the user 2116, and the system gets the next adaptive section 2114. At 2115, if the adaptive section is not found, then the system gets the next productive section 2117. Productive is a common language proficiency term. In an alternate embodiment, instead of including a productive section, the section is instead a specific skill section. The system checks if the productive section is found 2118. If yes, then the productive section is shown to a user on a display screen 2119, and the system gets the next productive section 2117. At 2118, if no, then the system calculates at least one of the user's ability estimate, misfit estimate, and standard error 2120. The system checks if the standard error exceeds the standard error threshold 2121. The system can use a lookup table and compare whether the standard error calculated for the user matches or has a value greater than or less than the stored standard error threshold value. At 2121, if the standard error is not a value greater than the standard error threshold value, then the system checks the misfit calculation to determine whether the misfit calculated value for the user is less than the misfit threshold value 2122. If yes, then the system sets the attempt status to ERROR 2123, and the test session is stopped 2130. At 2121, if the standard error is a value greater than the standard error threshold value, then the system sets the attempt status to ERROR 2123, and the test session is stopped 2130. At 2122, if the misfit calculated value is not less than the misfit threshold value, then the system sets the user's ability estimate to a calculated ability estimate 2132. The system calculates a result score and an associated result level based on the calculated ability estimate 2131. The system takes the skill tested in the assessment 2124. If the system finds the skill 2125, then the system calculates the ability estimate and standard error based on the items linked to that skill 2133. The system checks whether the standard error is greater than the standard error threshold 2134. If yes, then the system takes the next skill tested in the assessment 2124. If no, the system calculates the result score and the result level for a skill based on the calculated ability estimate 2136. The system defines a recommendation for a skill based on the calculated level 2135. In an embodiment, at 2135, recommendations are provided to a student or user based on how the student/user performed on the assessment. For example, because all items are tagged with at least a subskill and a skill tag, the system can lookup in a database or other storage medium the difficulty level already calculated for the skill tags and subskills. These difficulty levels are calculated by averaging the calibrated difficulty level of all items tagged within that skill tag or subskill. In an embodiment, a student/user is then given recommendations that have difficulty levels falling slightly higher than their estimated ability. For example, in the event that there are not enough items tagged with a subskill to make a recommendation on it, a student/user is given default recommendations appropriate to their estimated level. The default recommendations can be automatically generated via a lookup table or other storage medium. For example, a lookup table can be used with various calculated levels associated with different skills. For example, the system can dynamically search or scrape the Internet or web browsers for such information, if available. The system then takes the next skill tested in the assessment at 2124.

At 2125, if the skill is not found, then the system checks if the assessment contained productive section items 2126. If no, then the system sets the attempt status to complete 2129 and the testing session is stopped 2130. If yes, then the system sets the attempt status to pending 2127, the grader grades the productive section item answers 2128. The system sets the attempt status to complete 2129 and the testing session is stopped 2130.

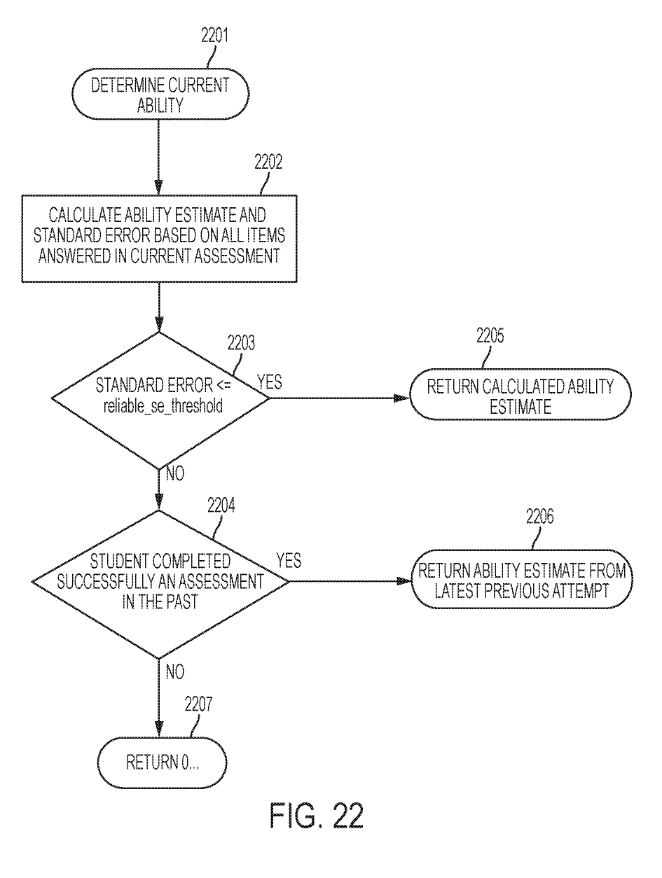

In FIG. 22, the system determines a user's current ability 2201. The ability estimate is calculated and a standard error based on all items answered in the current assessment is implemented 2202. The system checks if the standard error is less than or equal to the reliable standard error threshold 2203. At 2203, if yes, then the system returns the calculated ability estimate 2205. If no, then the system determines whether the user completed successfully an assessment in the past 2204. At 2204, if yes, then the system returns the ability estimate from the latest previous attempt by the user 2206 stored by the system. If no, then the system return a null value 2207. In an embodiment, specifically, in the case of a user taking a second, third, fourth, or more assessment, see, e.g., feature identified at 2204, this feature allows for a determination of current ability to be calculated based on the user's estimated ability from a previous assessment. This feature makes the embodiments of the present invention a progress tracking system.

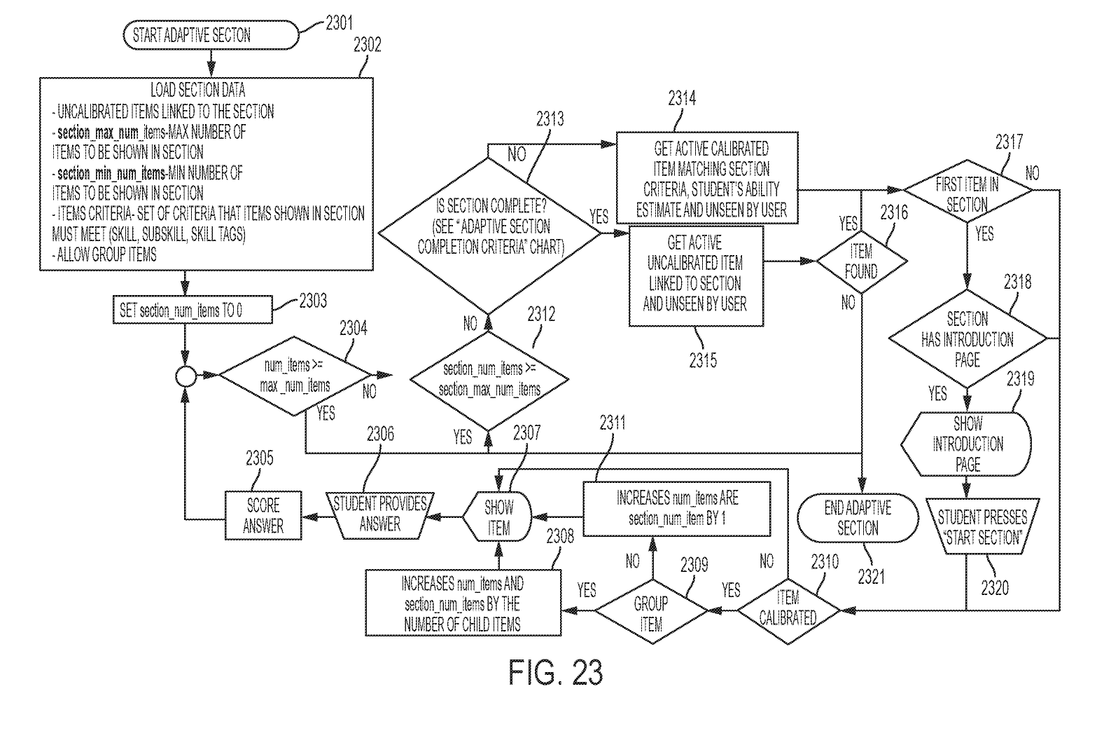

In FIG. 23, an example adaptive section process is described according to an embodiment of the present invention. At 2301, the adaptive section is started. The system loads section data 2302, loading, for example, at least one of uncalibrated items linked to the section, maximum number of items to be shown in section, set of criteria that items shown in the section must meet (skill, subskill, skill tags), and group items. The system sets the section number of items to zero or null 2303. The system checks if the number of items is greater than or equal to the maximum number of items 2304. If yes, then the system ends the adaptive section 2321. If no, then the system determines whether the section number of items is greater than or equal to the section maximum number of items 2312. At 2312, if yes, then the system ends the adaptive section 2321. At 2312, if no, then the system determines whether the second is complete 2313. At 2313, if yes, then the system gets an active uncalibrated item linked to the section and unseen by the user 2315. The system then determines whether the item is found 2316. At 2316, if no, then the system ends the adaptive section 2321. At 2316, if yes, then the system determines whether the item is the first item in the section 2317. At 2317, if no, then the system determines whether the item is calibrated 2310 and continues through the process. At 2317, if yes, then the system checks if the section has an introduction page 2318. At 2318, if no, then the system checks if the item is calibrated 2310 and continues through the process. At 2318, if yes, then the system displays or shows the introduction page 2319, and the user can be presented with a start button or other way to activate the start of the section 2320. The system then checks whether the item is calibrated 2310 and continues through the process.

At 2310, the system determines whether the item is calibrated. At 2310, if yes, then the system determines whether the item is part of a group of items 2309. At 2309, if yes, then the system increases the number of items and the second number of items values by the number of child items 2308. Then, the system shows the item to the user 2307, the user provides and answer 2306, the system scores the answer provided by the user 2305, and the process continues at 2304.

At 2310, if no, then the system shows the item to the user 2307, the user provides and answer 2306, the system scores the answer provided by the user 2305, and the process continues at 2304.

At 2309, if the system determines that the item is not part of a group, then the system increases the number of items and the second number of items values by 1 2311. The system then shows or displays the item to the user 2307, the user provides and answer 2306, the system scores the answer provided by the user 2305, and the process continues at 2304.

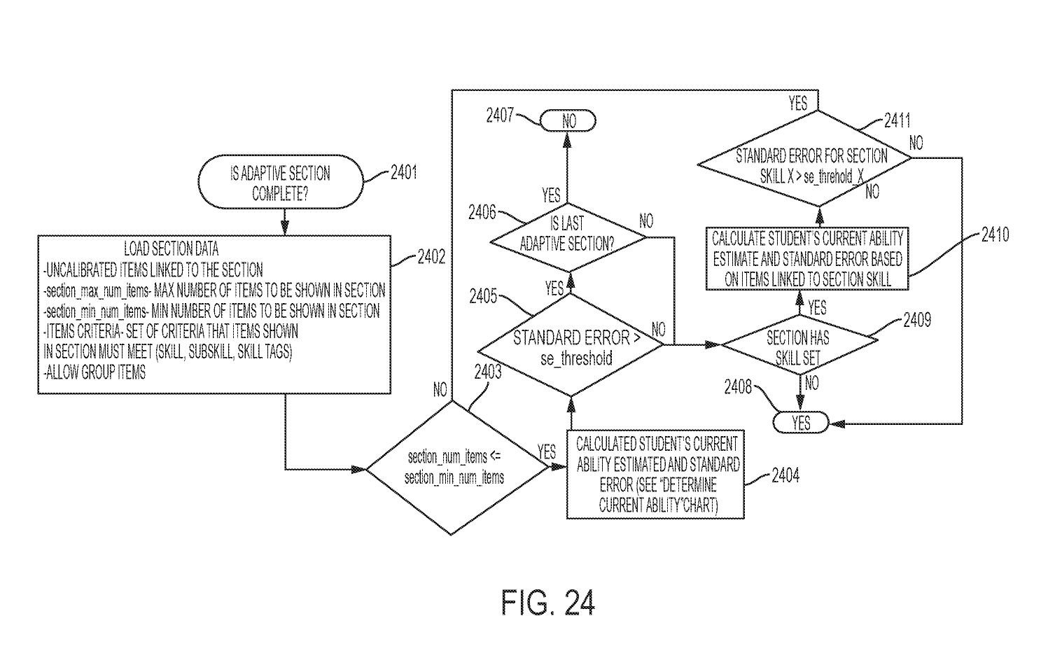

In FIG. 24, the system determines whether the adaptive section is complete 2401. At 2402, the system loads the section data, which can include at least one of: uncalibrated items linked to the section, a maximum number of items to be shown in the section, a set of criteria that items shown in the section must meet (skill, subskill, skill tags), and group items. The system determines whether the section number of items is less than or equal to the section minimum number of items 2403. At 2403, if yes, then the system calculates the student's current ability estimate and standard error 2404. The system then determines whether the standard error is greater than the standard error threshold 2405. At 2403, if no, then the system updates that the adaptive session is not complete 2407. At 2405, if yes, the system determines whether this is the last adaptive section 2406. At 2406, if yes, then the system updates that the adaptive session is not complete 2407. At 2406, if no, then the system checks whether the section has an associated skill set 2409. At 2405, if no, then the system checks whether the section has an associated skill set 2409. At 2409, if no, the system updates that the adaptive session is complete 2408. At 2409, if yes, the system calculates the user's current ability estimate and standard error based on items linked to a section skill 2410. The system then determines whether the standard error for a specific section skill is greater than the standard error threshold for that specific section skill 2411. At 2411, if yes, then the system updates that the adaptive session is not complete 2407. At 2411, if no, then the system updates that the adaptive session is complete 2408.

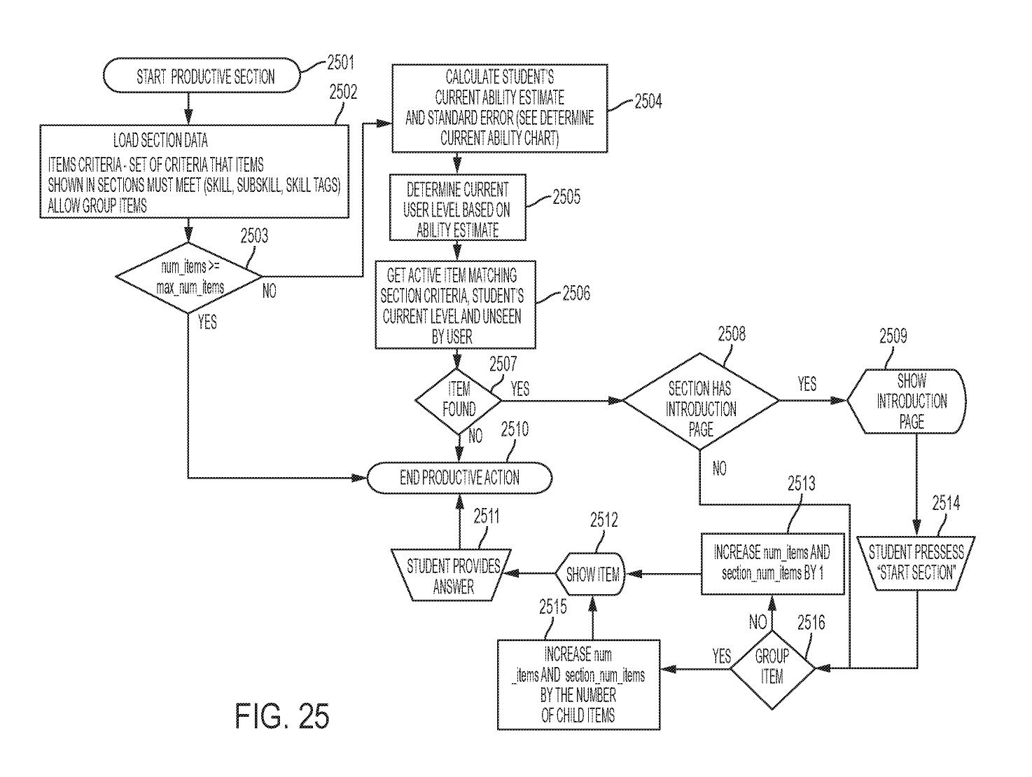

In FIG. 25, an example productive section process is described according to an embodiment of the present invention. At 2501, the productive section is started. At 2502, the system loads the section data, which can include, for example, items criteria which is a set of criteria that items shown in the section must meet (e.g., skill, subskill, skill tags). At 2503, the system determines whether the number of items value is greater than or equal to the maximum number of items. At 2503, if yes, then the system ends the productive section 2516. At 2503, if no, then the system calculates the user's current ability estimate and standard error 2504. See, e.g., FIG. 22 re determining the current ability. The system then determines a current user level based on the ability estimate 2505. The system then gets active item matching section criteria, and the user's current level which is unseen by the user 2506. The system checks whether the item is found 2507. At 2507, if no, then the productive section ends 2516. At 2507, if yes, then the system checks whether the section has an introduction page 2508. At 2508, if yes, then the system shows the introduction page 2509, and the user can press a button or trigger a start of the section 2510 via a user interface or other mode, and proceeds to 2512. At 2508, if no, the system goes to 2512 to determine if the item is a part of a group of items. At 2512, if the system determines that the item is not a part of a group, then the number of items value and section number of items value are increased by 1 2511. The item is then shown to the user 2514, the user provides an answer 2515, and the productive section ends 2516. At 2512, if the system determined that the item is a part of a group, then the number of items value and the section number of items value are each increased by the number of child items 2513. The system then shows the item 2514 to the user via a display screen or other mode, the user provides an answer 2515, and the productive section ends 2516.

In an embodiment, based on how a student performs on the receptive skills (e.g., grammar, reading, listening), the system is able to generate productive prompts that are level appropriate. The ability estimate is calculated and a prompt that is tagged to that level is given. These prompts are not calibrated so the logic responds differently and pulls based on the first layer of meta data which indicates an associated CEFR level. Presently, all other assessment systems appear to not provide these features.

In an embodiment, all items are tagged. The tagging system essentially feed the assessment engine and the recommendation engine. The four layers of metadata—that is, level, skill, subskill, and skill tag—essentially defines the identity of the item. In an embodiment, each item is tagged with one piece of information on each layer—level, skill, subskill, skill tag. That tagging identifies the identity of the item and allows for the item to be pulled or obtained by the system via its metadata. In a further embodiment, the system pulls the item via the metadata tag in order to average into a calculated difficulty level of a pool of items with the same metadata tag (e.g., same subskill or skill tag).

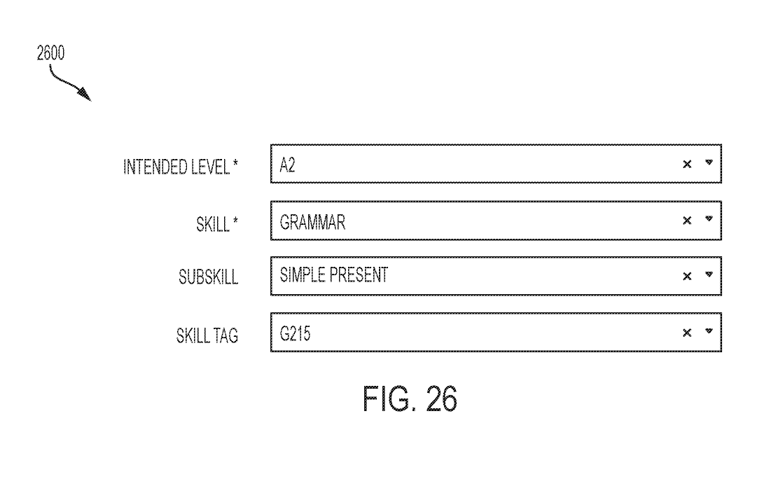

In FIG. 26, an example of the metadata that can be pulled by the system for an item is shown. For example, the four layers of metadata are shown along with an appropriate data 2600: intended level: A2; skill: grammar; subskill: simple present; and skill tag: G215. The A2 level is a known level common to a standard testing for English language proficiency. In an embodiment, each item in the system is tagged with these layers. In an embodiment, the system breaks the skills down further into micro skills, readability scores, etc.

In an embodiment, an example of a listening tag broken down into great detail is as follows. A skill tag is associated, e.g., with a descriptor, a category, a domain, a type of persons, a text source, a discourse type/nature of content, a length, speed, and articulation, word frequency and target discourse markers, lexical areas and topics, operations and areas to assess (assuming multiple choice with four options and only one correct response). These can be further broken down into more detail. For example, the operations and areas to assess can include understanding the gist (recognizing the topic, main ideas, and purpose), understand specific information (e.g., details, relationships, location, situation), understand speaker's attitude, opinion, and/or agreement, use a variety of strategies to achieve comprehension (including, listening for main points, checking comprehension by using contextual clues to identify cues and infer meaning). A tag L401, having descriptor regarding understanding standard spoken language, live or broadcast, on both familiar and unfamiliar topics normally encountered in personal, social, academic or vocational life; only extreme background noise, inadequate discourse structure and/or idiomatic usage influences the ability to understand, etc., is a part of the category overall listening comprehension. The associated domains is identified as applicable to all domains, e.g., personal, public, occupational, educational, academic. The associated persons is identified as applicable to all persons, e.g., friends, acquaintances, relatives, officials, employers, employees, colleagues, clients, customers, service personnel, professors/teachers, fellow students, newscasters, tv/radio show hosts, actors/audience members, etc. The associated text source includes debates and discussions (live and in the media), entertainment, interpersonal dialogues and conversations, news broadcasts, interviews, public announcements and instructions, public speeches, commercial texts, radio call-in show, recorded tourist information, routing commands (e.g., subway announcements regarding safety), telephone conversations, weather information, sports commentaries, rituals/ceremonies, job interviews, tv/radio documentaries, traffic information. The associated discourse type or nature of content include mainly argumentative, mainly descriptive/expository, mainly instructive, mainly persuasive, mainly narrative, and concrete or fairly abstract. The associated length, speed, and articulation include: length: short text: 0:25 (+/−20%), long text: 2:00 approximately; speed: 4.0-5.0 syllables per second, normal/occasional fast talker ok; articulation: normally articulated/sometimes unclearly articulated; may be some background noise; provide a variety of voices, styles of delivery and accents to reflect international context of test takers. The associated work frequency and target discourse markers include: rather extended, K1+K2+AWL=95-100%, Off list=0-5%; B2 Discourse Markers: Past-time sequential markers: See B1 markers; at the same time, meanwhile, previously, following this, subsequently, in the end, eventually; Cause/Effect: See B1 markers; consequently, as a result of, due to, in order that/to, for this reason; Contrast: Nevertheless, conversely, although, even though, though, in spite of, despite (the fact that); Comparison: either . . . or, neither . . . nor, both . . . and Formal Discourse: to begin, furthermore, moreover, regarding, additionally; and Informal spoken discourse: As B1: Uh-huh, Right (agreement), Really?, Are you sure? (surprise/doubt), Anyway (change of topic), I don't think so, uh-uh (disagree), etc. The associated lexical areas and topics include: Content knowledge, topic, genre & purpose etc. of input are familiar to young adults and adults, whatever their culture, and are of general interest; Test takers cannot answer without listening to the text; Text does contains a fair amount of abstract concepts; Texts are appropriate for all cultures and do not deal with negative topics such as illness, accidents or addiction; Includes detailed information on familiar and unfamiliar topics encountered in personal, social academic or vocational life; Texts can include: Describing past experiences and storytelling (V411), describing feelings and emotions (V412), Describing hopes and plans (V413), Giving precise information (V414), Expressing abstract ideas (V415), Expressing certainty, probability, and doubt (V416), Generalizing and qualifying (V417), Synthesizing, evaluating, and glossing info (V418), Speculating and Hypothesizing (V419), Expressing opinions (V420), Expressing agreement and disagreement (V421), Expressing reaction (V422), Critiquing and reviewing (V423), Developing an argument (V424), Prefixes and suffixes (V431), Contrasting opinions (V451), Summarizing exponents (V452), Collocation (V453), Colloquial language (V454), Technical, legal, and business language (V479); and B2 topics can include: Education (V472); Film (V473); Books and literature (V474); News, lifestyle, and current affairs (V475); Media (V476); Arts (V477), Technical, leg. The Operations and Areas to Assess are associated with four subgroups including understanding the gist (e.g., why did the man walk across the road?); understanding specific details (e.g., how will the man get across the road during rush hour?); understanding speaker's attitude (e.g., how did the man feel about the jaywalking rules resulting in a ticket?); and using a variety of strategies to achieve comprehension (e.g., what does the word “swollen” mean in the conversation? Larger than usual/broken/bloody/painful). The skills can be broken down further, and this can be effected for each skill of interest in the assessment and/or training system and method.

Herein, the various embodiments refer generally to the system. For purposes of brevity, the “system” term is used in reference to the various embodiments of the processes of the present invention, the method of the present invention, and computer-readable instructions for implementing the method of the present invention.

For each of the processes described in FIGS. 1 to 25, portions of each can be deleted from the processes or portions of each can be added to the processes without departing from the scope of the invention. The above processes provide some example embodiments of the novel system, method, and computer-readable medium described.

The modifications listed herein and other modifications can be made by those in the art without departing from the scope of the invention. Although the invention has been described above with reference to specific embodiments, the invention is not limited to the above embodiments and the specific configurations shown in the drawings. For example, some components shown can be combined with each other as one embodiment, and/or a component can be divided into several subcomponents, and/or any other known or available component can be added. The processes and implementation embodiments are also not limited to those shown in the examples. Those skilled in the art will appreciate that the invention can be implemented in other ways without departing from the substantive features of the invention. For example, features and embodiments described above can be combined with and without each other. The present embodiments are therefore to be considered in all respects as illustrative and not restrictive. Other embodiments can be utilized and derived therefrom, such that structural and logical substitutions and changes can be made without departing from the scope of this disclosure. This Specification, therefore, is not to be taken in a limiting sense, along with the full range of equivalents to which such claims are entitled.

Such embodiments of the inventive subject matter can be referred to herein, individually and/or collectively, by the term “invention” for convenience and without intending to voluntarily limit the scope of this application to any single invention or inventive concept if more than one is in fact disclosed. It should be appreciated that the present invention can be implemented in numerous ways, including as a process, an apparatus, a system, a computer processor executing software instructions, or a computer readable medium such as a non-transitory computer readable storage medium, or a computer network wherein program instructions are sent over optical or electronic communication or non-transitory links. It should be noted that the order of the steps of disclosed processes can be altered within the scope of the invention, as noted in the appended claims and in the description herein.

The computer processor and algorithm for conducting aspects of the methods of the present invention may be housed in devices that include desktop computers, scientific instruments, hand-held devices, personal digital assistants, phones, a non-transitory computer readable medium, and the like. The methods need not be carried out on a single processor. For example, one or more steps may be conducted on a first processor, while other steps are conducted on a second processor. The processors may be located in the same physical space or may be located distantly. In some such embodiments, multiple processors are linked over an electronic communications network, such as the Internet. Preferred embodiments include processors associated with a display device for showing the results of the methods to a user or users, outputting results as a video image and the processors may be directly or indirectly associated with information databases. As used herein, the terms processor, central processing unit, and CPU are used interchangeably and refer to a device that is able to read a program from a computer memory, e.g. ROM or other computer memory, and perform a set of steps according to the program. The terms computer memory and computer memory device refer to any storage media readable by a computer processor. Examples of computer memory include, but are not limited to, RAM, ROM, computer chips, digital video discs, compact discs, hard disk drives and magnetic tape. Also, computer readable medium refers to any device or system for storing and providing information, e.g., data and instructions, to a computer processor, DVDs, CDs, hard disk drives, magnetic tape and servers for streaming media over networks.

Embodiments of the present invention provide for accessing data obtained via a user's smartphone, smart device, tablet, iPad®, iWatch®, or other device and transmit that information via a telecommunications, WiFi, or other network option to a location, or other device, processor, or computer which can capture or receive information and transmit that information to a location. In an embodiment, the device is a portable device with connectivity to a network or a device or a processor. Embodiments of the present invention provide for a computer software application (or “app”) or other method or device which operates on a device such as a portable device having connectivity to a communications system to interface with a user to obtain specific data, push or allow for a pull, of that specific data by a device such as a processor, server, or storage location. In embodiments, the server runs a computer software program to determine which data to use, and then transforms and/or interprets that data in a meaningful way.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. The various features of embodiments described can be used with and without each other, in various combinations. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. An adaptive system, comprising:
a user interface;
an item delivery and data collection system;
an estimation engine; and
a storage medium,
wherein the item delivery and data collection system administers a test via the user interface and collects data from the test administration, inputting the data to the estimation engine which determines an estimated ability, and storing the estimated ability in a storage medium.

2. The system of claim 1, further comprising a report generator, wherein the report generator generates a report based on at least one of the data and the estimated ability.

3. The system of claim 2, wherein the report concerns at least one of: a language proficiency level; a change in language proficiency level over time; skill strength; skill weakness; descriptive data for a specific reader; and data export.

4. The system of claim 1, wherein the storage medium is at least one of: a mobile device memory, a database, a server, a cloud-based storage medium, and a portable storage device.

5. The system of claim 1, wherein the estimation engine employs an item response theory assessment, scaling, and/or estimation of the data.

6. The system of claim 1, wherein the user interface is at least one of: an interactive screen; a display screen; a computer monitor; a cloud-based interface; a smartboard, and a mobile screen.

7. A method, comprising:
identifying an entity in an assessment system;
determining whether the entity has previously been assessed in the system, and, if yes, then the estimated level associated with the entity is obtained by the assessment system and the entity is entered into a testing sequence applicable to the estimated level, and, if no, then the entity is entered into an initial testing sequence;
wherein an item response theory engine scales any data obtained by the assessment system to determine at least one score for assessing an ability of the entity.

8. The method of claim 7, wherein the assessment system is adaptive, further comprising reviewing data from at least one of the testing sequence or a section, determining using the item response theory engine the at least one score, and assessing using the at least one score to determine a next testing sequence for the entity.

9. The method of claim 7, wherein the at least one score concerns English language fluency.

10. A computer-readable medium having instructions thereon to be implemented by a processor, comprising the system of claim 1.

11. A computer-readable medium having instructions thereon to be implemented by a processor, comprising the method of claim 7.
